(19) United States
(12) Patent Application Publication
(10) Pub. No.: US 2004/0037196 A1
(43) Pub. Date: Feb. 26, 2004

(54) Optical information reproducing apparatus and optical information recording/reproducing apparatus

(75) Inventors: Kozo Matsumoto, Kanagawa (JP); Hideyoshi Horimai, Kanagawa (JP); Wataru Kubo, Tokyo (JP); Suguru Takishima, Tokyo (JP)

Correspondence Address: OLIFF & BERRIDGE, PLC, P.O. BOX 19928, ALEXANDRIA, VA, 22320, US

(73) Assignees: OPTWARE CORPORATION, Yokohama-shi (JP); PENTAX CORPORATION, Itabashi-ku (JP)

(21) Appl. No.: 10/641,072

(22) Filed: Aug. 15, 2003

(30) Foreign Application Priority Data
Aug. 26, 2002 (JP) 2002-244726

(51) Int. Cl. G11B 7/00

(52) U.S. Cl. 369/53.19; 369/103

(57) ABSTRACT

To record information, a recording/reproducing optical system in an optical head irradiates a recording medium with information light and reference light for recording so that two-dimensional image information is recorded on the recording medium by means of interference between the information light and the reference light for recording. To reproduce information, the recording/reproducing optical system irradiates the recording medium with reference light for reproduction, and collects and detects reproduction light occurring from the recording medium. An optical information recording/reproducing apparatus comprises a tilt detector and an image deviation correction circuit. The tilt detector detects a tilt of the recording medium with respect to a predetermined reference position. Based on the output signal of the tilt detector, the image deviation correction circuit moves a lens which constitutes part of the optical system in the optical head, thereby correcting a displacement between a solid state image pick-up device in the optical head and the image of the reproduction light incident on the solid state image pick-up device.

### BACKGROUND OF THE INVENTION

1. Field of the Invention

The present invention relates to an optical information reproducing apparatus for reproducing two-dimensional image information from a recording medium through the use of holography, and to an optical information recording/reproducing apparatus for recording two-dimensional image information on a recording medium and reproducing the two-dimensional image information from the recording medium through the use of holography.

In general, holographic recording for recording information on a recording medium through the use of holography is performed by superimposing light that carries image information on reference light within the recording medium and by writing an interference pattern resulting therefrom into the recording medium. To reproduce the information recorded, the recording medium is irradiated with reference light. The image information is thereby reproduced through diffraction derived from the interference pattern.

In recent years, volume holography, or digital volume holography in particular, has been developed and is attracting attention in practical fields for ultra-high density optical recording. Volume holography is a method for writing a three-dimensional interference pattern by making positive use of a recording medium in the direction of its thickness as well. It has such a feature that the diffraction efficiency is enhanced by increasing the thickness of the medium, and a greater recording capacity is achieved by employing multiplex recording. Digital volume holography is a computer-oriented holographic recording method which uses the same recording medium and recording method as with the volume holography, whereas the image information to be recorded is limited to binary digital patterns. In the digital volume holography, analog image information such as a picture is once digitized and developed into two-dimensional digital pattern information, and then it is recorded as image information. For reproduction, this digital pattern information is read and decoded to restore the original image information for display. Consequently, even if the signal-to-noise ratio (hereinafter referred to as SN ratio) during reproduction is somewhat poor, it is possible reproduce the original information with extremely high fidelity by performing differential detection and/or error correction on the binary data encoded.

To record information on a recording medium through the use of holography as described above, information light which carries two-dimensional image information and reference light for recording are projected onto an identical area of the recording medium. Then, the information is recorded on the recording medium in the form of an interference pattern as a result of interference between the information light and the reference light for recording.

For example, an optical information recording/reproducing apparatus for recording information on a recording medium through the use of holography and reproducing the information from the recording medium through the use of holography may be configured such that an optical system for recording and reproduction is accommodated in an optical head which is movable with respect to a rotating disk-like recording medium.

In general, the information light is generated by a spatial light modulator having a plurality of pixels. It follows that the information light and the reproduction light each have a plurality of pixels. The reproduction light is typically detected by a photodetector having a plurality of pixels. To reproduce information accurately, it is therefore necessary to align the pixels of the photodetector and the pixels of the reproduction light projected on the photodetector with precision.

In the optical information recording/reproducing apparatus configured as described above, however, the positional relationship between the optical system in the optical head and the recording medium can vary due to such reasons as the tilt of the recording medium. This causes a problem that the positional relationship between the pixels of the photodetector and the pixels of the reproduction light varies to preclude accurate reproduction of information.

### OBJECT AND SUMMARY OF THE INVENTION

A first object of the invention is to provide an optical information reproducing apparatus which is capable of reproducing two-dimensional image information accurately from a recording medium through the use of holography.

A second object of the invention is to provide an optical information recording/reproducing apparatus for recording two-dimensional image information on a recording medium through the use of holography and reproducing the two-dimensional image information from the recording medium through the use of holography, thereby allowing accurate reproduction of two-dimensional image information from a recording medium.

An optical information reproducing apparatus of the invention serves to reproduce two-dimensional image information from a recording medium through the use of holography, the two-dimensional image information being recorded on the recording medium by means of interference between information light carrying the two-dimensional image information and reference light for recording. The apparatus comprises a reproduction reference light generator and a reproducing optical system. The reproduction reference light generator generates reference light for reproduction. The reproducing optical system irradiates the recording medium with the reference light for reproduction generated by the reproduction reference light generator, and collects reproduction light. The reproduction light occurs from the recording medium irradiated with the reference light for reproduction, and carries the two-dimensional image information. The apparatus further comprises a reproduction light detector, a reproduction light displacement detector, and a correction unit. The reproduction light detector detects the reproduction light collected by the reproducing optical system and incident on the reproduction light detector. The reproduction light displacement detector detects reproduction light displacement information pertaining to a displacement between the reproduction light detector and the reproduction light incident on the reproduction light detector. The correction unit corrects the displacement based on the reproduction light displacement information detected by the reproduction light displacement detector.

According to the optical information reproducing apparatus of the invention, the reproduction light occurring from the recording medium irradiated with the reference light for reproduction is detected by the reproduction light detector. In the optical information reproducing apparatus, the reproduction light displacement detector detects reproduction light displacement information which pertains to a displacement between the reproduction light detector and the reproduction light incident on the reproduction light detector. Based on this information, the correction unit corrects the displacement.

An optical information recording/reproducing apparatus of the invention serves to record two-dimensional image information on a recording medium through the use of holography and reproduce the two-dimensional image information from the recording medium through the use of holography. The apparatus comprises an information light generator for generating information light carrying the two-dimensional image information, a recording reference light generator for generating reference light for recording, a reproduction reference light generator for generating reference light for reproduction, and a recording/reproducing optical system. To record information, the recording/reproducing optical system irradiates the recording medium with the information light generated by the information light generator and the reference light for recording generated by the recording reference light generator so that the two-dimensional image information is recorded on the recording medium by means of interference between the information light and the reference light for recording. To reproduce information, the optical system irradiates the recording medium with the reference light for reproduction generated by the reproduction reference light generator and collects reproduction light. The reproduction light occurs from the recording medium irradiated with the reference light for reproduction and carries the two-dimensional image information. The apparatus further comprises a reproduction light detector, a reproduction light displacement detector, and a correction unit. The reproduction light detector detects the reproduction light collected by the recording/reproducing optical system and incident on the reproduction light detector. The reproduction light displacement detector detects reproduction light displacement information pertaining to a displacement between the reproduction light detector and the reproduction light incident on the reproduction light detector. The correction unit corrects the displacement based on the reproduction light displacement information detected by the reproduction light displacement detector.

According to the optical information recording/reproducing apparatus of the invention, to record information, the recording medium is irradiated with the information light and the reference light for recording. By means of interference between the information light and the reference light for recording, two-dimensional image information is recorded on the recording medium. To reproduce the information, the reproduction light occurring from the recording medium irradiated with reference light for reproduction is detected by the reproduction light detector. In the optical information recording/reproducing apparatus, the reproduction light displacement detector detects reproduction light displacement information which pertains to a displacement between the reproduction light detector and the reproduction light incident on the reproduction light detector. Based on this information, the correction unit corrects the displacement.

In the optical information reproducing apparatus or the optical information recording/reproducing apparatus of the invention, the reproduction light displacement detector may detect information on a tilt of the recording medium with respect to a predetermined reference position, as the reproduction light displacement information.

The optical information reproducing apparatus or the optical information recording/reproducing apparatus of the invention may further comprise a reference light position information detector for detecting information on a positional relationship between the recording medium and the reference light for reproduction incident on the recording medium. The reproduction light displacement detector may use the reference light position information detector to detect information on a tilt of the recording medium with respect to a predetermined reference position, as the reproduction light displacement information.

In the optical information reproducing apparatus or the optical information recording/reproducing apparatus of the invention, the reproduction light displacement detector may use the reproduction light detector to detect the reproduction light displacement information.

In the optical information reproducing apparatus or the optical information recording/reproducing apparatus of the invention, the correction unit may have a lens for correction that constitutes part of the recording/reproducing optical system, and a moving mechanism for moving the lens for correction. The moving mechanism may move the lens for correction in at least one direction out of a direction intersecting an optical axis of the lens for correction, a direction of the optical axis of the lens for correction, and such a direction as to change the angle formed between a traveling direction of the reproduction light incident on the lens for correction and the direction of the optical axis of the lens for correction.

Other objects, features and advantages of the invention will become sufficiently clear from the following description.

### BRIEF DESCRIPTION OF THE DRAWINGS

FIG. 1 is a block diagram showing a general configuration of an optical information recording/reproducing apparatus according to the first embodiment of the invention.

FIG. 2 is an explanatory diagram showing a configuration of essential parts of a recording/reproducing optical system in an optical head of the optical information recording/reproducing apparatus according to the first embodiment.

FIG. 3 is a plan view showing a movable portion of the optical head and the surroundings thereof in the optical information recording/reproducing apparatus according to the first embodiment.

FIG. 4 is an explanatory diagram showing a recording medium and a light-emitting portion of the optical head of the optical information recording/reproducing apparatus according to the first embodiment.

FIG. 5 is an explanatory diagram showing a position-controlling optical system of the optical head of the optical information recording/reproducing apparatus according to the first embodiment.

FIG. 6 is an explanatory diagram showing the recording medium used in the first embodiment.

FIG. 7 is an explanatory diagram for explaining polarized light used in the first embodiment.

FIG. 8 is an explanatory diagram for explaining a servo operation of the optical information recording/reproducing apparatus according to the first embodiment.

FIG. 9 is an explanatory diagram for explaining an information recording operation of the optical information recording/reproducing apparatus according to the first embodiment.

FIG. 10 is an explanatory diagram for explaining an information reproducing operation of the optical information recording/reproducing apparatus according to the first embodiment.

FIG. 11 is an explanatory diagram for explaining movements of a track and the irradiating position for information light and reference light for recording during the information recording by the optical information recording/reproducing apparatus according to the first embodiment.

FIG. 12 is a perspective view showing a tilt detector of the first embodiment.

FIG. 13 is an explanatory diagram for explaining the operation of the tilt detector shown in FIG. 12.

FIG. 14 is an explanatory diagram for explaining the operation of the tilt detector shown in FIG. 12.

FIG. 15 is an explanatory diagram showing the configuration of a relay lens system of the first embodiment.

FIG. 16 is an aberration chart showing a spherical aberration and a chromatic aberration of the relay lens system shown in FIG. 15.

FIG. 17 is an aberration chart showing an astigmatic aberration of the relay lens system shown in FIG. 15.

FIG. 18 is an aberration chart showing a distortion aberration of the relay lens system shown in FIG. 15.

FIG. 19 is an aberration chart showing a coma aberration of the relay lens system shown in FIG. 15.

FIG. 20 is an aberration chart showing a coma aberration of the relay lens system shown in FIG. 15.

FIG. 21 is an aberration chart showing a coma aberration of the relay lens system shown in FIG. 15.

FIG. 22 is an aberration chart showing a coma aberration of the relay lens system shown in FIG. 15.

FIG. 23 is an explanatory diagram showing the state of the relay lens system shown in FIG. 15 at a magnification of −1.53.

FIG. 24 is an explanatory diagram showing the state of the relay lens system shown in FIG. 15 at a magnification of −1.75.

FIG. 25 is an explanatory diagram showing the state of the relay lens system shown in FIG. 15 at a magnification of −2.03.

FIG. 26 is a characteristic chart showing the relationship between the position of the lens for correction and the magnification in the relay lens system shown in FIG. 15.

FIG. 27 is a characteristic chart showing the relationship between the position of the lens for correction and the amount of movement of the image of the reproduction light in the relay lens system shown in FIG. 15.

FIG. 28 is a characteristic chart showing the relationship between the tilt of the optical axis of the lens for correction and the amount of movement of the image of the reproduction light in the relay lens system shown in FIG. 15.

FIG. 29 is a front view of a lens moving mechanism of the first embodiment.

FIG. 30 is a cross-sectional view taken along line 30-30 of FIG. 29.

FIG. 31 is a perspective view of the lens moving mechanism shown in FIG. 29.

FIG. 32 is an exploded perspective view of the lens moving mechanism shown in FIG. 29.

FIG. 33 is an exploded perspective view of a lens moving mechanism of a second embodiment of the invention.

FIG. 34 is a front view of the lens moving mechanism of the second embodiment.

FIG. 35 is a cross-sectional view taken along line 35-35 of FIG. 34.

FIG. 36 is a cross-sectional view taken along line 36-36 of FIG. 34.

FIG. 37 is an explanatory diagram for explaining a method of detecting a tilt of the recording medium by using a quadripartite photodetector in a third embodiment of the invention.

FIG. 38 is an explanatory diagram for explaining a method of detecting a displacement between a solid state image pick-up device and the reproduction light incident on the solid state image pick-up device by using the solid state image pick-up device in a fourth embodiment of the invention.

### DETAILED DESCRIPTION OF THE PREFERRED EMBODIMENTS

Hereinafter, embodiments of the invention will be described in detail with reference to the drawings.

[First Embodiment]

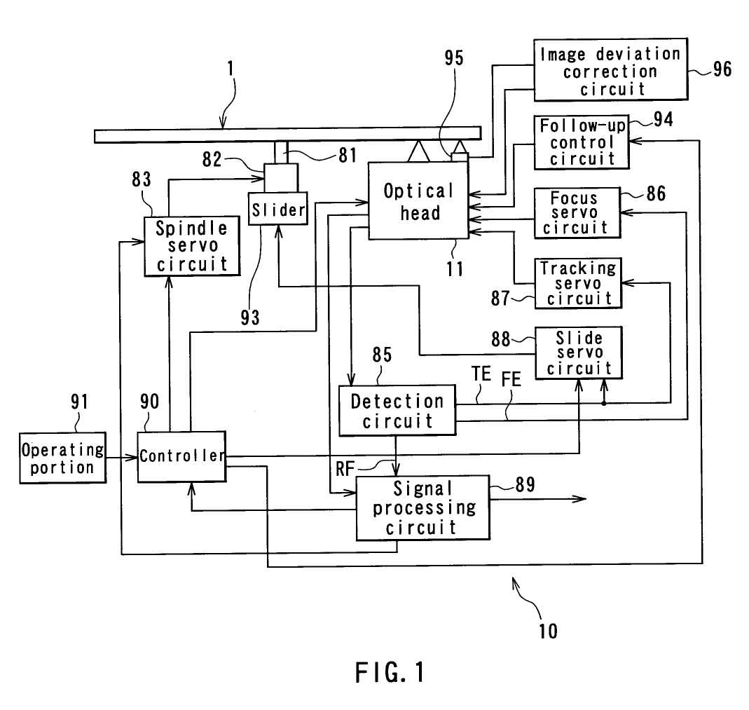

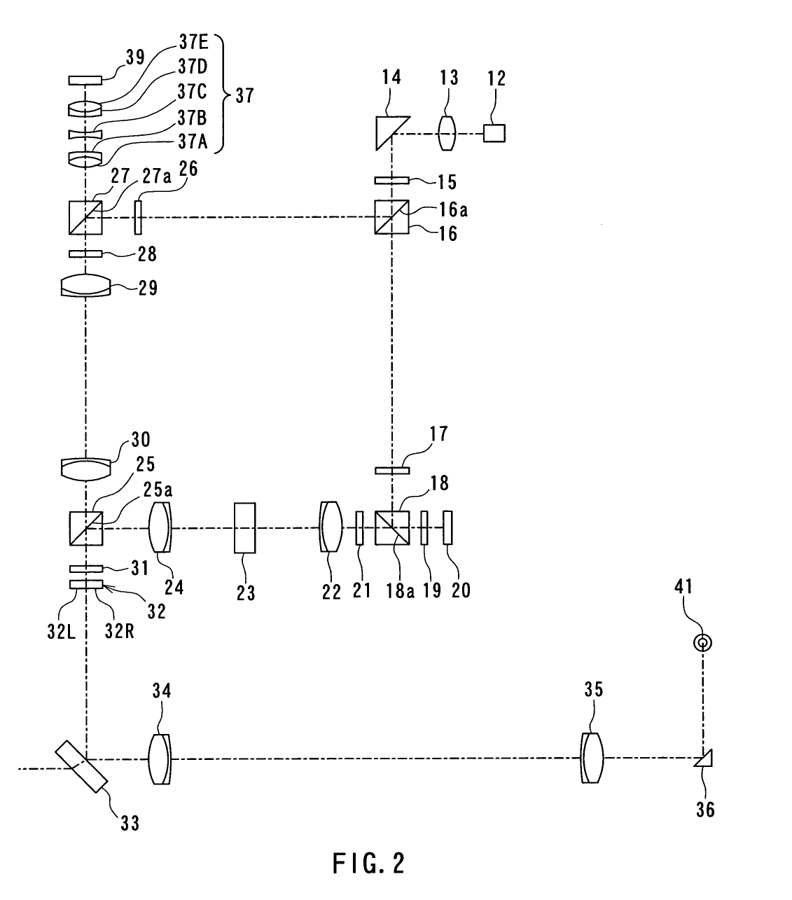

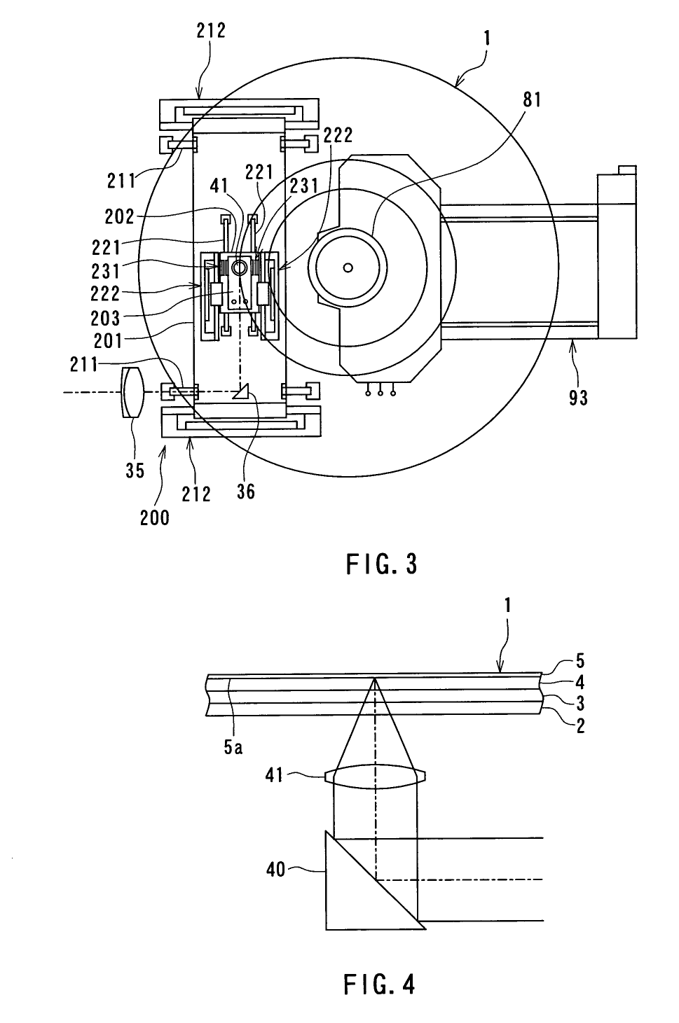

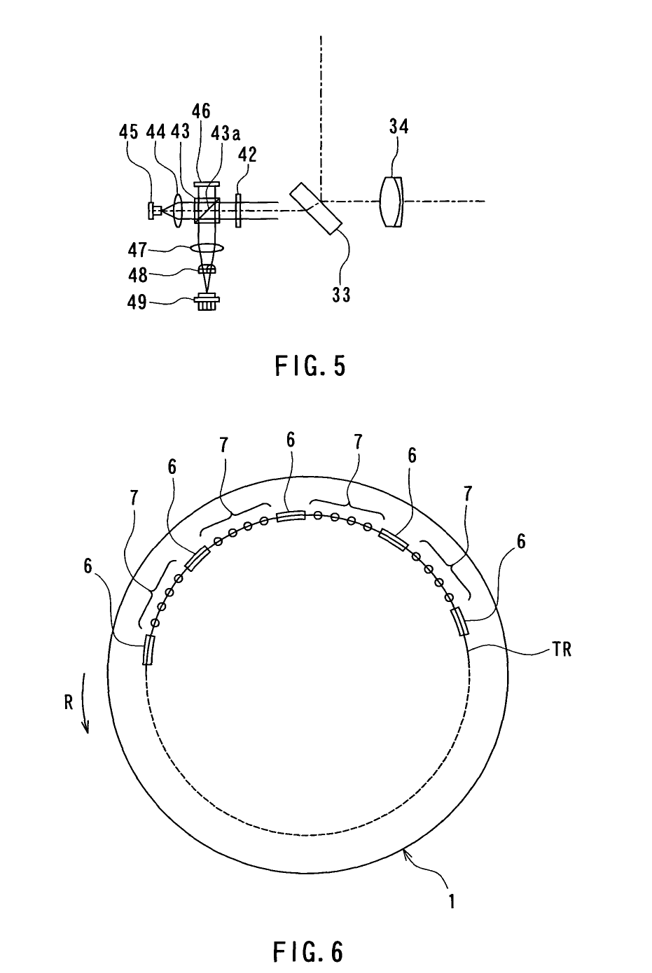

Initially, reference is made to FIG. 1 to FIG. 6 to describe a configuration of an optical information recording/reproducing apparatus according to a first embodiment of the invention. FIG. 1 is a block diagram showing the general configuration of the optical information recording/reproducing apparatus according to the present embodiment. FIG. 2 is an explanatory diagram showing the configuration of essential parts of a recording/reproducing optical system in an optical head of the optical information recording/reproducing apparatus. FIG. 3 is a plan view showing a movable portion of the optical head and the surroundings thereof. FIG. 4 is an explanatory diagram showing a recording medium and a light-emitting portion of the optical head of the optical information recording/reproducing apparatus. FIG. 5 is an explanatory diagram showing a position-controlling optical system in the optical head. FIG. 6 is an explanatory diagram showing the recording medium used in the present embodiment. The optical information recording/reproducing apparatus according to the present embodiment includes an optical information reproducing apparatus according to the present embodiment. The recording/reproducing optical system in the present embodiment includes a reproducing optical system.

First, a configuration of the recording medium used in the present embodiment will be described with reference to FIG. 4 and FIG. 6. As shown in FIG. 4, the recording medium 1 used in the present embodiment comprises a disk-like transparent substrate 2 made of polycarbonate or the like, and an information recording layer 3, a transparent substrate 4, and a reflecting layer 5 that are arranged in this order, the information recording layer 3 being closest to the transparent substrate 2, on the side of the transparent substrate 2 opposite from the light incidence/exit side. The transparent substrate 4 may be replaced with an air gap layer. The information recording layer 3 is a layer in which information is recorded through the use of holography, and is made of a hologram material which varies, when irradiated with light, in its optical characteristics such as refractive index, permittivity, and reflectance, depending on the intensity of the light. For example, hologram materials such as photopolymer HRF-600 (product name) manufactured by Dupont and photopolymer ULSH-500 (product name) manufactured by Aprils may be used. The reflecting layer 5 is made of aluminum, for example. The surface of the reflecting layer 5 facing the transparent substrate 4 serves as a reflecting surface 5a for reflecting light for recording or reproducing information.

FIG. 6 shows part of a track of the recording medium 1. The recording medium 1 is disk-shaped and has a plurality of tracks TR. Each of the tracks TR has a plurality of address servo areas 6 arranged at regular intervals. One or more information recording areas 7 are provided between adjacent ones of the address servo areas 6. FIG. 6 shows a case where four information recording areas 7 are arranged at regular intervals between adjacent ones of the address servo areas 6.

Information for generating a basic clock, i.e., a timing reference for various operations of the optical information recording/reproducing apparatus, information for performing focus servo using a sampled servo system, information for performing tracking servo using the sampled servo system, and address information are recorded in advance in the form of emboss pits or the like in the address servo areas 6. However, the information for performing focus servo is not necessarily required to be recorded in the address servo areas 6, and focus servo may be performed using the reflecting surface 5a. The address information is intended for identifying the individual information recording areas 7.

Next, the configuration of the optical information recording/reproducing apparatus according to the embodiment will be described with reference to FIG. 1. The optical information recording/reproducing apparatus 10 comprises: a spindle 81 on which the recording medium 1 is mounted; a spindle motor 82 for rotating the spindle 81; a spindle servo circuit 83 for controlling the spindle motor 82 to keep the rotation speed of the recording medium 1 at a predetermined value; and a slider 93 for moving the spindle motor 82 in a horizontal direction. The optical information recording/reproducing apparatus 10 further comprises an optical head 11 that is placed to face one of the surfaces (the bottom surface in FIG. 1) of the recording medium 1. The optical head 11 irradiates the recording medium 1 with information light and reference light for recording so as to record information, and irradiates the recording medium 1 with reference light for reproduction and detects reproduction light so as to reproduce the information recorded in the recording medium 1.

The optical information recording/reproducing apparatus 10 further comprises a detection circuit 85, a focus servo circuit 86, a tracking servo circuit 87, and a slide servo circuit 88. The detection circuit 85 detects a focus error signal FE, a tracking error signal TE and a reproduction signal RF from output signals of the optical head 11. The focus servo circuit 86 performs focus servo by driving an actuator in the optical head 11 based on the focus error signal FE detected by the detection circuit 85 to move an objective lens in the optical head 11 in the direction of the thickness of the recording medium 1. The tracking servo circuit 87 performs tracking servo by driving a linear motor in the optical head 11 based on the tracking error signal TE detected by the detection circuit 85 to move the objective lens in the direction of the radius of the recording medium 1. The slide servo circuit 88 performs slide servo by controlling the slider 93 based on the tracking error signal TE and a command from a controller to be described later to move the spindle motor 82 in a horizontal direction.

The optical information recording/reproducing apparatus 10 further comprises a follow-up control circuit 94. During information recording, the follow-up control circuit 94 moves the irradiating position for the information light and the reference light for recording in a direction generally along the tracks, so that the irradiating position for the information light and the reference light for recording is controlled so as to follow a single moving information recording area 7 for a predetermined period.

The optical information recording/reproducing apparatus 10 further comprises a tilt detector 95 and an image deviation correction circuit 96. The tilt detector 95 is fixed to a surface (the top surface in FIG. 1) of the optical head 11 facing toward one of the surfaces of the recording medium 1, and detects a tilt of the recording medium 1 with respect to a predetermined reference position. The image deviation correction circuit 96 receives input of the output signal of the tilt detector 95. Based on the output signal of the tilt detector 95, the image deviation correction circuit 96 moves a lens which constitutes part of the optical system in the optical head 11, thereby correcting a displacement between a solid state image pick-up device in the optical head, which will be described later, and the image of the reproduction light incident on the solid state image pick-up device. The tilt detector 95 corresponds to the reproduction light displacement detector of the invention.

The optical information recording/reproducing apparatus 10 further comprises a signal processing circuit 89, a controller 90, and an operating portion 91. The signal processing circuit 89 decodes data outputted by the solid state image pick-up device in the optical head 11 to thereby reproduce data recorded in the information recording areas 7 of the recording medium 1. It also reproduces a basic clock and determines addresses from the reproduction signal RF from the detection circuit 85. The controller 90 controls the optical information recording/reproducing apparatus 10 as a whole. The operating portion 91 supplies various instructions to the controller 90. The controller 90 receives input of the basic clock and address information outputted by the signal processing circuit 89 and controls the parts such as the optical head 11, the spindle servo circuit 83, the slide servo circuit 88 and the follow-up control circuit 94. The basic clock outputted by the signal processing circuit 89 is inputted to the spindle servo circuit 83. The controller 90 has a CPU (central processing unit), a ROM (read only memory) and a RAM (random access memory). The CPU executes programs stored in the ROM using the RAM as a work area to perform the functions of the controller 90.

Next, with reference to FIG. 2, description will be given of the configuration of essential parts of the recording/reproducing optical system in the optical head 11 of the present embodiment. The optical head 11 has a light source device 12 that emits coherent linearly polarized laser light, and a collimator lens 13, a mirror 14, a half-wave plate 15, and a polarization beam splitter 16 that are arranged in this order, the collimator lens 13 being closest to the light source device 12, on the optical path of the light emitted by the light source device 12. For example, the light source device 12 is a semiconductor laser for emitting green light of a single wavelength. Green light refers to light whose wavelength falls within the range of approximately 492 to 577 nm. The polarization beam splitter 16 has a polarization beam splitter surface 16a for reflecting S-polarized light and transmitting P-polarized light. S-polarized light is linear polarized light whose direction of polarization is perpendicular to the plane of incidence (plane of the drawing sheet of FIG. 2). P-polarized light is linear polarized light whose direction of polarization is in parallel with the plane of incidence.

The optical head 11 further comprises a half-wave plate 17 and a polarization beam splitter 18 that are arranged in this order, the half-wave plate 17 being closer to the polarization beam splitter 16, along the traveling direction of light that is incident on the polarization beam splitter 16 from the half-wave plate 15 and transmitted through the polarization beam splitter surface 16a. The polarization beam splitter 18 has a polarization beam splitter surface 18a for reflecting S-polarized light and transmitting P-polarized light.

The optical head 11 further comprises a quarter-wave plate 19 and a reflection type spatial light modulator 20 that are arranged in this order, the quarter-wave plate 19 being closer to the polarization beam splitter 18, along the traveling direction of light that is incident on the polarization beam splitter 18 from the half-wave plate 17 and reflected off the polarization beam splitter surface 18a. The reflection type spatial light modulator 20 has a number of pixels arranged in a matrix, and is capable of generating information light that carries two-dimensional image information by spatially modulating light in terms of intensity by selecting a light-transmitting state or a light-blocking state pixel by pixel.

The optical head 11 further comprises a half-wave plate 21, a convex lens 22, a pin hole 23, a convex lens 24, and a polarization beam splitter 25 that are arranged in this order, the half-wave plate 21 being closest to the polarization beam splitter 18, along the traveling direction of light that is incident on the polarization beam splitter 18 from the quarter-wave plate 19 and transmitted through the polarization beam splitter surface 18a. The polarization beam splitter 25 has a polarization beam splitter surface 25a for reflecting S-polarized light and transmitting P-polarized light.

The optical head 11 further comprises a phase spatial light modulator 26 and a polarization beam splitter 27 that are arranged in this order, the phase spatial light modulator 26 being closer to the polarization beam splitter 16, along the traveling direction of light that is incident on the polarization beam splitter 16 from the half-wave plate 15 and reflected off the polarization beam splitter surface 16a. The phase spatial light modulator 26 has a number of pixels arranged in a matrix, and is capable of spatially modulating the phase of light by selecting the phase of the outgoing light pixel by pixel. A liquid crystal device may be used for the phase spatial light modulator 26. The polarization beam splitter 27 has a polarization beam splitter surface 27a for reflecting S-polarized light and transmitting P-polarized light.

The optical head 11 further comprises a half-wave plate 28, a convex lens 29, and a convex lens 30 that are arranged in this order, the half-wave plate 28 being closest to the polarization beam splitter 27, along the traveling direction of light that is incident on the polarization beam splitter 27 from the phase spatial light modulator 26 and reflected off the polarization beam splitter surface 27a. The light having passed through the convex lenses 29 and 30 travels in a direction orthogonal to the traveling direction of light incident on the polarization beam splitter 25 from the convex lens 24, and then enters the polarization beam splitter 25.

The optical head 11 further comprises a shortwave pass filter 31, a bipartite optical rotation plate 32, and a dichroic mirror 33 that are arranged in this order, the shortwave pass filter 31 being closest to the polarization beam splitter 25, along the traveling direction of light that is incident on the polarization beam splitter 25 from the convex lens 24 and reflected by the polarization beam splitter surface 25a and light that is incident on the polarization beam splitter 25 from the convex lens 30 and transmitted through the polarization beam splitter surface 25a. The shortwave pass filter 31 transmits green light and blocks red light. Red light refers to light whose wavelength falls within the range of approximately 622 to 770 nm. The bipartite optical rotation plate 32 includes optical rotation plates 32L and 32R disposed on the left side and the right side, respectively, of the optical axis as viewed in FIG. 2. The optical rotation plate 32R causes a −45° rotation of the direction of polarization, while the optical rotation plate 32L causes a +45° rotation of the direction of polarization. The dichroic mirror 33 reflects green light and transmits red light.

In the present embodiment, the bipartite optical rotation plate 32 is disposed at a position conjugate to the position of the reflection type spatial light modulator 20. To be more specific, the reflection type spatial light modulator 20 has an image forming plane on which an image corresponding to information is formed. The image forming plane and the bipartite optical rotation plate 32 are disposed at mutually conjugate positions about the optical system located therebetween. The image formed by the reflection type spatial light modulator 20 thus forms an image on the bipartite optical rotation plate 32.

In the present embodiment, the phase spatial light modulator 26 is disposed at a position conjugate to the bipartite optical rotation plate 32. To be more specific, the phase spatial light modulator 26 has an image forming plane on which an image modulated spatially in phase is formed. This image forming plane and the bipartite optical rotation plate 32 are disposed at mutually conjugate positions about the optical system located therebetween. The image formed by the phase spatial light modulator 26 thus forms an image on the bipartite optical rotation plate 32.

The optical head 11 further comprises a convex lens 34, a convex lens 35, and a mirror 36 that are arranged in this order, the convex lens 34 being closest to the dichroic mirror 33, along the traveling direction of light that enters the dichroic mirror 33 from the bipartite optical rotation plate 32 and is reflected by the same.

Light that has entered the mirror 36 from the convex lens 35 and has been reflected by the mirror 36 enters the movable portion shown in FIG. 3.

The optical head 11 further comprises a relay lens system 37 and a solid state image pick-up device 39 that are arranged in this order, the relay lens system 37 being closer to the polarization beam splitter 27, along the traveling direction of light that enters the polarization beam splitter 27 from the half-wave plate 28 and is transmitted through the polarization beam splitter surface 27a. For example, a CCD or an MOS type solid state image pick-up device is used as the solid state image pick-up device 39. The solid state image pick-up device 39 corresponds to the reproduction light detector of the invention. The signal processing circuit 89 in FIG. 1 processes output signals of the solid state image pick-up device 39 to reproduce two-dimensional image information.

The relay lens system 37 has a convex lens 37A, a concave lens 37B, a concave lens 37C, a concave lens 37D, and a convex lens 37E that are arranged in this order, the convex lens 37A being closest to the polarization beam splitter 27. The convex lens 37A and the concave lens 37B are joined with each other. The concave lens 37D and the convex lens 37E are joined with each other. The concave lens 37C is movable by means of a lens moving mechanism to be described later. The relay lens system 37 projects the image of the reproduction light onto the solid state image pick-up device 39. In this relay lens system 37, the position and size of the image of the reproduction light projected onto the solid state image pick-up device 39 can be adjusted by moving the concave lens 37C. The concave lens 37C corresponds to the lens for correction of the invention.

The optical head 11 further comprises the position-controlling optical system shown in FIG. 5. The position-controlling optical system comprises a red transmission filter 42, a beam splitter 43, a collimator lens 44, and a light source device 45 that are arranged in this order, the red transmission filter 42 being closest to the dichroic mirror 33, on the side of the dichroic mirror 33 opposite from the convex lens 34. The beam splitter 43 has a semi-reflecting surface 43a whose normal direction is inclined 45° with respect to the direction of the optical axis of the collimator lens 44. The red transmission filter 42 transmits red light and blocks light of the other wavelength bands. For example, the light source device 45 is a semiconductor laser for emitting red light of a single wavelength. The optical head 11 further comprises a photodetector 46 disposed in the traveling direction of light that enters the beam splitter 43 from the collimator lens 44 and is reflected off the semi-reflecting surface 43a. The photodetector 46 is used to monitor the quantity of light emitted by the light source device 45 and to perform auto adjustment of the quantity of light emitted by the light source device 45.

The optical head 11 further comprises a convex lens 47, a cylindrical lens 48, and a quadripartite photodetector 49 that are disposed in this order, the convex lens 47 being closest to the beam splitter 43, on the side of the beam splitter 43 opposite from the photodetector 46. The quadripartite photodetector 49 has four light receiving portions which are divided by a division line that is parallel to a direction corresponding to the direction of tracks of the recording medium 1 and a division line that is orthogonal thereto. The cylindrical lens 48 is situated such that the central axis of the cylindrical surface thereof forms an angle of 45° with respect to the division lines of the quadripartite photodetector 49. The quadripartite photodetector 49 detects information on the positional relationship between the recording medium 1 and the reference light for reproduction incident on the recording medium 1. The quadripartite photodetector 49 corresponds to the reference light position information detector of the invention.

Now, the configuration of the movable portion of the optical head 11 will be described with reference to FIG. 3 and FIG. 4. The movable portion 200 of the optical head 11 has an objective lens 41 and a mirror 40 that constitute part of the recording/reproducing optical system. As shown in FIG. 4, the objective lens 41 is disposed to face the transparent substrate 2 of the recording medium 1. The mirror 40 is disposed on a side of the objective lens 41 opposite from the recording medium 1.

The movable portion 200 of the optical head 11 includes a first movable portion 201 and a second movable portion 202. Two rails 211 extending in the direction of the radius of the recording medium 1 (horizontal direction in FIG. 3) are attached to the body of the optical information recording/reproducing apparatus. The first movable portion 201 is supported by the two rails 211 so as to be movable in the direction of the radius of the recording medium 1. The optical head 11 further has linear motors 212 for moving the first movable portion 201 with respect to the body of the optical information recording/reproducing apparatus in the direction of the radius of the recording medium 1.

Two rails 221 extending in a direction tangential to the tracks (vertical direction in FIG. 3) are attached to the first movable portion 201. The second movable portion 202 is supported by the two rails 221 so as to be movable in a direction tangential to the tracks. The optical head 11 further has linear motors 222 for moving the second movable portion 202 with respect to the first movable portion 201 in a direction tangential to the tracks.

A support plate 203 for supporting the objective lens 41 to be movable in a direction perpendicular to the surface of the recording medium 1 (a direction orthogonal to the plane of the drawing sheet of FIG. 3) is attached to the second movable portion 202. The optical head 11 also has an actuator 231 for moving the objective lens 41 with respect to the second movable portion 202 in a direction perpendicular to the surface of the recording medium 1.

The mirror 40 is fixed to the first movable portion 201. Light which has entered the mirror 36 from the convex lens 35 in FIG. 3 and has been reflected by the same enters the mirror 40 shown in FIG. 4 and is reflected by the same. The light reflected by the mirror 40 is collected by the objective lens 41 and applied to the recording medium 1. Light which has entered the objective lens 41 from the recording medium 1 is collected by the objective lens 41, is reflected by the mirrors 40 and 36 in succession, and passes through the convex lenses 35 and 34 in succession.

According to the optical head 11 of the present embodiment, the actuator 231 can change the position of the objective lens 41 in a direction perpendicular to the surface of the recording medium 1, thereby effecting focus servo. According to the optical head 11, the linear motors 212 can change the position of the objective lens 41 in a direction of the radius of the recording medium 1, thereby effecting tracking servo. Furthermore, according to the optical head 11, the linear motors 222 can change the position of the objective lens 41 in a direction tangential to the tracks, i.e., in a direction generally along the tracks. This allows control of the irradiating position for the information light and the reference light for recording to follow the information recording areas 7. Access to a desired track is achieved by moving the spindle motor 82 in a horizontal direction with the slider 93.

The actuator 231 is driven by the focus servo circuit 86 of FIG. 1. The linear motors 212 are driven by the tracking servo circuit 87 of FIG. 1. The linear motors 222 are driven by the follow-up control circuit 94 of FIG. 1. The slider 93 is driven by the slide servo circuit 88 of FIG. 1.

The light source devices 12 and 45, the reflection type spatial light modulator 20, and the phase spatial light modulator 26 in the optical head 11 are controlled by the controller 90 of FIG. 1. The controller 90 holds information on a plurality of modulation patterns for spatially modulating the phase of light with the phase spatial light modulator 26. The operating portion 91 can select any one of the plurality of modulation patterns. Then, the controller 90 supplies the information on the modulation pattern selected by itself or by the operating portion 91 to the phase spatial light modulator 26 in accordance with predetermined conditions. In accordance with the information on the modulation pattern supplied by the controller 90, the phase spatial light modulator 26 spatially modulates the phase of light in the corresponding modulation pattern.

Now, an overview will be given of the operation of the optical system in the optical head 11 shown in FIG. 2 to FIG. 5. The light source device 12 emits S-polarized or P-polarized linear green light. The light emitted by the light source device 12 is collimated by the collimator lens 13 and reflected by the mirror 14. Then, the light is subjected to a 45° rotation of the direction of polarization through the half-wave plate 15, and thereby becomes light that contains both S-polarized components and P-polarized components. This light is incident on the polarization beam splitter 16. The P-polarized components of the light incident on the polarization beam splitter 16 pass through the polarization beam splitter surface 16a of the polarization beam splitter 16, while the S-polarized components are reflected off the polarization beam splitter surface 16a of the polarization beam splitter 16.

The P-polarized light having passed through the polarization beam splitter surface 16a is subjected to a 90° rotation of the direction of polarization through the half-wave plate 17, and becomes S-polarized light. This light is reflected off the polarization beam splitter surface 18a of the polarization beam splitter 18. Then, it passes through the quarter-wave plate 19 to become circularly polarized light, and is incident on the spatial light modulator 20. The light incident on the spatial light modulator 20 is spatially modulated in intensity by the spatial light modulator 20, and exits the spatial light modulator 20 as information light. The information light that has exited the spatial light modulator 20 passes through the quarter-wave plate 19 to become P-polarized light, and then passes through the polarization beam splitter surface 18a of the polarization beam splitter 18. This light passes through the half-wave plate 21 to become S-polarized light. This light passes through the convex lens 22, the pin hole 23, and the convex lens 24 in succession, enters the polarization beam splitter 25, and is reflected off the polarization beam splitter surface 25a to enter the shortwave pass filter 31.

Meanwhile, the S-polarized light reflected off the polarization beam splitter surface 16a enters the phase spatial light modulator 26. The phase spatial light modulator 26 spatially modulates the phase of light by setting the phase of the outgoing light pixel by pixel to either of two values differing by π (rad) from each other, for example. The light modulated by the phase spatial light modulator 26 becomes reference light for recording or reference light for reproduction. The light that has exited the phase spatial light modulator 26 enters the polarization beam splitter 27 and is reflected off the polarization beam splitter surface 27a. This light is subjected to a 45° rotation of the direction of polarization through the half-wave plate 28, and then passes through the convex lenses 29 and 30 to enter the polarization beam splitter 25. Part of this light passes through the polarization beam splitter surface 25a to enter the shortwave pass filter 31.

The light which exits the polarization beam splitter 25 to enter the shortwave pass filter 31 is the information light, the reference light for recording, or the reference light for reproduction. The light is green light. The light passes through the shortwave pass filter 31 and the bipartite optical rotation plate 32, is reflected by the dichroic mirror 33, and passes through the convex lenses 34 and 35 in succession. The light is then reflected by the mirrors 36 and 40 in succession, collected by the objective lens 41 and applied to the recording medium 1. The information light, the reference light for recording and the reference light for reproduction, which are green light, are coaxially applied to one side of the information recording layer 3 of the recording medium 1 so as to converge to become minimum in diameter on the reflecting surface 5a.

Return light from the recording medium 1 corresponding to the green light applied to the recording medium 1 is collimated or roughly collimated by the objective lens 41. The resulting light passes through the mirrors 40 and 36, the convex lenses 35 and 34, the dichroic mirror 33, the bipartite optical rotation plate 32, and the shortwave pass filter 31, and is incident on the polarization beam splitter 25. As will be detailed later, the light incident on the polarization beam splitter 25 includes S-polarized light and P-polarized light. Of these, the S-polarized light is reflected off the polarization beam splitter surface 25a, while the P-polarized light passes through the polarization beam splitter surface 25a. The P-polarized light having passed through the polarization beam splitter surface 25a passes through the convex lenses 30 and 29, and is subjected to a 45° rotation of the direction of polarization through the half-wave plate 28. Then, the light enters the polarization beam splitter 27. Part of this light passes through the polarization beam splitter surface 27a and through the relay lens system 37, and enters the solid state image pick-up device 39.

Meanwhile, red light emitted by the light source device 45 is collimated by the collimator lens 44 and is then incident on the beam splitter 43. Part of the light incident on the beam splitter 43 is reflected off the semi-reflecting surface 43a and enters the photodetector 46, while the other part of the light passes through the semi-reflecting surface 43a. The light having passed through the semi-reflecting surface 43a becomes position-controlling light. The position-controlling light passes through the red transmission filter 42 and the dichroic mirror 33 in succession, and further passes through the convex lenses 34 and 35 in succession. The light is then reflected by the mirrors 36 and 40 in succession, collected by the objective lens 41, and is applied to the recording medium 1. The position-controlling light is applied to the recording medium 1 so as to converge to become minimum in diameter on the reflecting surface 5a of the recording medium 1.

Return light from the recording medium 1 corresponding to the red light applied to the recording medium 1 is collimated by the objective lens 41, passes through the mirrors 40, 36 and the convex lenses 35, 34, and is incident on the dichroic mirror 33. This light passes through the dichroic mirror 33 and the red transmission filter 42 in succession, and is then incident on the beam splitter 43. Part of the light incident on the beam splitter 43 is reflected off the semi-reflecting surface 43a and passes through the convex lens 47 and the cylindrical lens 48 in succession. Then, it is detected by the quadripartite photodetector 49. Based on the output of the quadripartite photodetector 49, the detection circuit 85 generates a focus error signal FE, a tracking error signal TE, and a reproduction signal RF. Based on these signals, focus servo and tracking servo are performed for controlling the position of the information light, the reference light for recording and the reference light for reproduction with respect to the recording medium 1, while the basic clock is reproduced and addresses are determined.

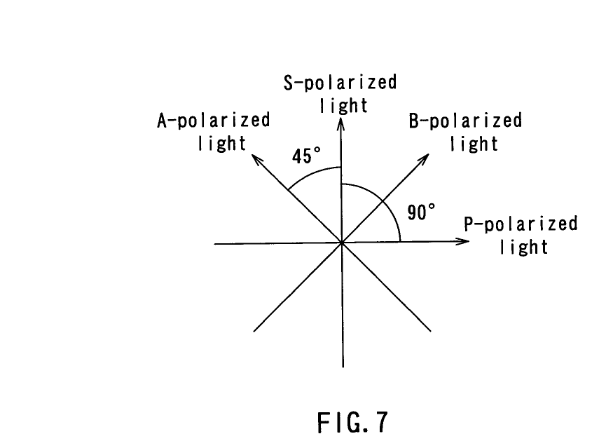

Now, with reference to FIG. 7, definitions will be given to terms “A-polarized light” and “B-polarized light” which will be used later in this specification. As shown in FIG. 7, A-polarized light is linear polarized light obtained by rotating the direction of polarization of the S-polarized light by −45° or by rotating the direction of polarization of the P-polarized light by +45°, while B-polarized light is linear polarized light obtained by rotating the direction of polarization of the S-polarized light by +45° or by rotating the direction of polarization of the P-polarized light by −45°. The directions of polarization of the A-polarized light and B-polarized light are orthogonal to each other.

Servo, information recording, and information reproducing operations of the optical information recording/reproducing apparatus according to the embodiment will now be individually described.

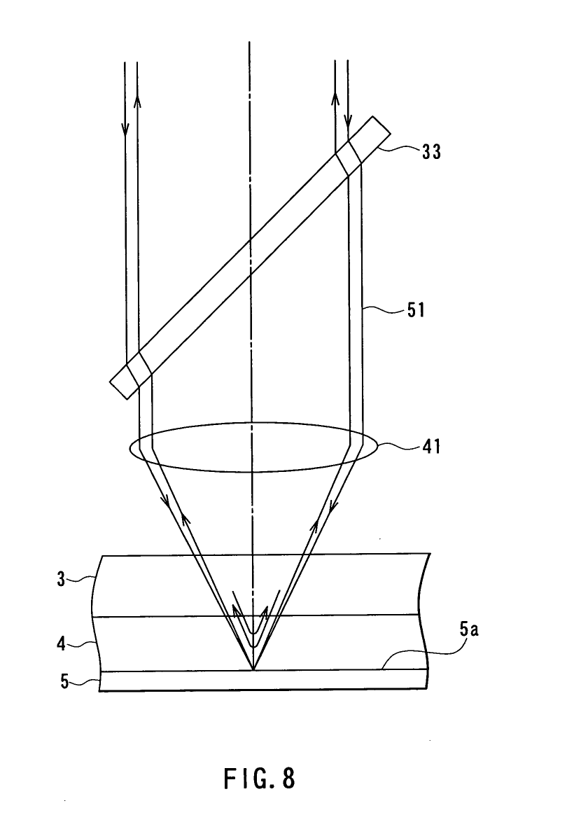

The servo operation will now be described with reference to FIG. 8. FIG. 8 is an explanatory diagram showing the state of light during the servo operation. For optical parts, FIG. 8 shows the dichroic mirror 33 and the objective lens 41 alone. For the servo operation, the light source device 45 emits red light. The light source device 12 emits no green light. As previously described, the position-controlling light 51 that is emitted by the light source device 45 passes through the collimator lens 44, the beam splitter 43, the red transmission filter 42, the dichroic mirror 33, the convex lenses 34 and 35, and the mirrors 36 and 40, and is applied to the recording medium 1 from the objective lens 41. The position-controlling light 51 is reflected off the reflecting surface 5a of the recording medium 1, passes through the objective lens 41, the mirrors 40 and 36, the convex lenses 35 and 34, the dichroic mirror 33, the red transmission filter 42, the beam splitter 43, the convex lens 47, and the cylindrical lens 48, and is detected by the quadripartite photodetector 49. Based on the output of the quadripartite photodetector 49, the detection circuit 85 generates a focus error signal FE, a tracking error signal TE, and a reproduction signal RF. Based on these signals, focus servo and tracking servo are performed, the basic clock is reproduced, and addresses are determined. In the present embodiment, focus servo is performed such that the position-controlling light 51 converges to become minimum in diameter on the reflecting surface 5a of the recording medium 1.

The controller 90 predicts the timing at which the light having exited the objective lens 41 passes through the address servo areas 6 based on the basic clock reproduced from the reproduction signal RF, and maintains the foregoing setting for the period in which the light that has exited the objective lens 41 passes through the address servo areas 6.

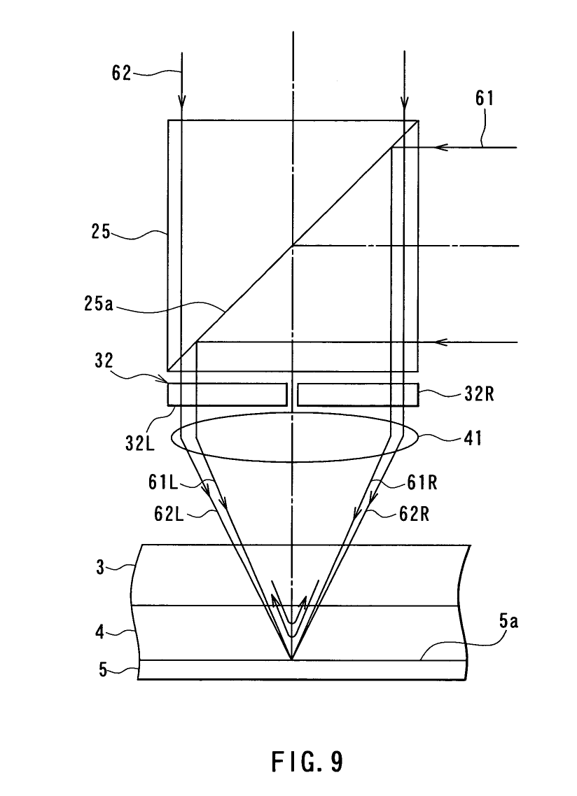

The information recording operation will now be described with reference to FIG. 9. FIG. 9 is an explanatory diagram showing the state of light during the information recording operation. For optical parts, FIG. 9 shows the polarization beam splitter 25, the bipartite optical rotation plate 32, and the objective lens 41 alone.

For the information recording operation, the light source device 12 emits green light. The light source device 45 emits no red light. Under the control of the controller 90, the power of the light emitted by the light source device 12 is set to a high level suitable for recording over a given period of time. Neither focus servo nor tracking servo is performed for the period in which the light having exited the objective lens 41 passes through areas other than the address servo areas 6. For that period, the objective lens 41 is fixed at a position determined by the previously-performed focus servo and tracking servo.

The light emitted by the light source device 12 is divided into two beams by the polarization beam splitter 16. One of the beams is modulated by the spatial light modulator 20 to become information light 61. The other of the beams is modulated by the phase spatial light modulator 26 to become reference light 62 for recording. The information light 61 and the reference light 62 for recording are combined by the polarization beam splitter 25 to enter the bipartite optical rotation plate 32. Before entering the bipartite optical rotation plate 32, the information light 61 is S-polarized light while the reference light 62 for recording is P-polarized light.

The information light 61R that has passed through the optical rotation plate 32R of the bipartite optical rotation plate 32 becomes A-polarized light, while the information light 61L that has passed through the optical rotation plate 32L of the bipartite optical rotation plate 32 becomes B-polarized light. The reference light 62R for recording that has passed through the optical rotation plate 32R of the bipartite optical rotation plate 32 becomes B-polarized light, while the reference light 62L for recording that has passed through the optical rotation plate 32L of the bipartite optical rotation plate 32 becomes A-polarized light.

The information light 61L, 61R and the reference light 62L, 62R for recording that have passed through the bipartite optical rotation plate 32 are collected by the objective lens 41 and coaxially applied to the same side of the recording medium 1. The information light 61L, 61R and the reference light 62L, 62R for recording converge to become minimum in diameter on the reflecting surface 5a of the recording medium 1.

The information light 61R that enters the recording medium 1 after passing through the optical rotation plate 32R is A-polarized light. The reference light 62L for recording that enters the recording medium 1 after passing through the optical rotation plate 32L is also A-polarized light. The A-polarized reference light 62L for recording is reflected off the reflecting surface 5a of the recording medium 1, and passes through the same area in the information recording layer 3 as the A-polarized information light 61R yet to be reflected off the reflecting surface 5a does. The light 62L and the light 61R interfere with each other to form an interference pattern because their directions of polarization coincide with each other. Meanwhile, the A-polarized information light 61R is reflected off the reflecting surface 5a of the recording medium 1, and passes through the same area in the information recording layer 3 as the A-polarized reference light 62L yet to be reflected off the reflecting surface 5a does. The light 62L and the light 61R also interfere with each other to form an interference pattern because their directions of polarization coincide with each other. Thus, the interference pattern resulting from the interference between the A-polarized information light 61R yet to enter the reflecting surface 5a and the A-polarized reference light 62L reflected off the reflecting surface 5a, and the interference pattern resulting from the interference between the A-polarized reference light 62L yet to enter the reflecting surface 5a and the A-polarized information light 61R reflected off the reflecting surface 5a are volumetrically recorded in the information recording layer 3.

The information light 61L that enters the recording medium 1 after passing through the optical rotation plate 32L is B-polarized light. The reference light 62R for recording that enters the recording medium 1 after passing through the optical rotation plate 32R is also B-polarized light. The B-polarized reference light 62R for recording is reflected off the reflecting surface 5a of the recording medium 1, and passes through the same area in the information recording layer 3 as the B-polarized information light 61L yet to be reflected off the reflecting surface 5a does. The light 61L and the light 62R interfere with each other to form an interference pattern because their directions of polarization coincide with each other. On the other hand, the B-polarized information light 61L is reflected off the reflecting surface 5a of the recording medium 1, and passes through the same area in the information recording layer 3 as the B-polarized reference light 62R yet to be reflected off the reflecting surface 5a does. The light 61L and the light 62R also interfere with each other to form an interference pattern because their directions of polarization coincide with each other. Thus, the interference pattern resulting from the interference between the B-polarized information light 61L yet to enter the reflecting surface 5a and the B-polarized reference light 62R reflected off the reflecting surface 5a, and the interference pattern resulting from the interference between the B-polarized reference light 62R yet to enter the reflecting surface 5a and the B-polarized information light 61L reflected off the reflecting surface 5a are volumetrically recorded in the information recording layer 3.

The information light 61R that has passed through the optical rotation plate 32R and the information light 61L that has passed through the optical rotation plate 32L do not interfere with each other because they differ in direction of polarization by 90°. Likewise, the reference light 62R for recording that has passed through the optical rotation plate 32R and the reference light 62L for recording that has passed through the optical rotation plate 32L do not interfere with each other because they differ in direction of polarization by 90°.

According to the present embodiment, it is possible to record a plurality of pieces of information in an identical location of the information recording layer 3 on a multiplex basis through phase-encoding multiplexing by changing the modulation pattern of the phase of the reference light for recording for each piece of the information to be recorded.

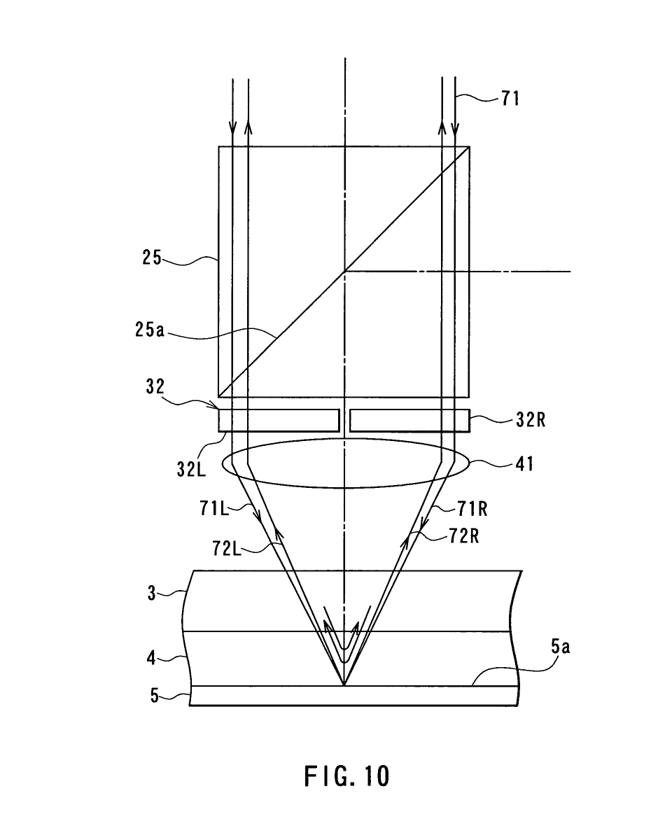

The information reproducing operation will now be described with reference to FIG. 10. FIG. 10 is an explanatory diagram showing a state of light during the reproducing operation.

For the information reproducing operation, the light source device 12 emits green light. The light source device 45 emits no red light. Under the control of the controller 90, the power of the light emitted by the light source device 12 is set to a low level suitable for reproduction. Neither focus servo nor tracking servo is performed for the period in which the light having exited the objective lens 41 passes through areas other than the address servo areas 6. For that period, the objective lens 41 is fixed at a position determined by the previously-performed focus servo and tracking servo.

In the spatial light modulator 20, all the pixels are brought into a light-blocking state. The light emitted by the light source device 12 is divided into two beams by the polarization beam splitter 16. One of the beams is blocked by the spatial light modulator 20. The other of the beams is modulated by the phase spatial light modulator 26 to become reference light 71 for reproduction. The reference light 71 for reproduction passes through the polarization beam splitter 25 to enter the bipartite optical rotation plate 32. The reference light 71 for reproduction is P-polarized light before it enters the bipartite optical rotation plate 32.

The reference light 71R for reproduction that has passed through the optical rotation plate 32R of the bipartite optical rotation plate 32 becomes B-polarized light, while the reference light 71L for reproduction that has passed through the optical rotation plate 32L of the bipartite optical rotation plate 32 becomes A-polarized light.

The reference light 71L, 71R for reproduction, having passed through the bipartite optical rotation plate 32, is collected by the objective lens 41 and applied to the recording medium 1. The reference light 71L, 71R for reproduction converges to become minimum in diameter at the same position where the information light 61L, 61R and the reference light 62L, 62R for recording converge to become minimum in diameter, that is, on the reflecting surface 5a.

The reference light 71R for reproduction that enters the recording medium 1 after passing through the optical rotation plate 32R is B-polarized light. The reference light 71L for reproduction that enters the recording medium 1 after passing through the optical rotation plate 32L is A-polarized light. In the information recording layer 3, the reference light for reproduction yet to be reflected of f the reflecting surface 5a causes reproduction light that travels away from the reflecting surface 5a, while the reference light for reproduction reflected off the reflecting surface 5a causes reproduction light that travels toward the reflecting surface 5a. The reproduction light traveling away from the reflecting surface 5a exits as-is from the recording medium 1. The reproduction light traveling toward the reflecting surface 5a is reflected off the reflecting surface 5a and then exits the recording medium 1.

The reproduction light is collimated by the objective lens 41 and then enters the bipartite optical rotation plate 32. The reproduction light 72R to enter the optical rotation plate 32R of the bipartite optical rotation plate 32 is B-polarized light before entering the optical rotation plate 32R, and becomes P-polarized light after passing through the optical rotation plate 32R. The reproduction light 72L to enter the optical rotation plate 32L of the bipartite optical rotation plate 32 is A-polarized light before entering the optical rotation plate 32L, and becomes P-polarized light after passing through the optical rotation plate 32L. Thus, the reproduction light having passed through the bipartite optical rotation plate 32 is P-polarized across the entire cross section of the beam thereof. The reproduction light having passed through the bipartite optical rotation plate 32 enters the solid state image pick-up device 39. The relay lens system 37 allows the two-dimensional image carried by the reproduction light to be formed on the solid state image pick-up device 39.

On the solid state image pick-up device 39, formed is an image of the intensity pattern of the light caused by the spatial light modulator 20 at the recording operation. Two-dimensional image information is reproduced by detecting this pattern. When a plurality of pieces of information are recorded in the information recording layer 3 on a multiplex basis by changing modulation patterns of the reference light for recording, among the plurality of pieces of information, the one corresponding to the modulation pattern of the reference light for reproduction is only reproduced.

The reference light 71R for reproduction that has entered the recording medium 1 after passing through the optical rotation plate 32R is reflected off the reflecting surface 5a and exits the recording medium 1. The light then passes through the optical rotation plate 32L and is converted into S-polarized return light. The reference light 71L for reproduction that has entered the recording medium 1 after passing through the optical rotation plate 32L is reflected off the reflecting surface 5a and exits the recording medium 1. The light then passes through the optical rotation plate 32R and is converted into S-polarized return light. Thus, the return light having passed through the bipartite optical rotation plate 32 is S-polarized across the entire cross section of the beam thereof. Since this return light is reflected off the polarization beam splitter surface 25a of the polarization beam splitter 25, it does not enter the solid state image pick-up device 39.

As has been described, according to the present embodiment, at information recording, the information light and the reference light for recording are applied coaxially to one side of the information recording layer 3 so as to converge to become minimum in diameter on the reflecting surface Sa.

Furthermore, at information recording, the reference light for recording polarized in a first direction (P-polarized) and the information light polarized in a second direction (S-polarized) that is different from the first direction are each optically rotated by the bipartite optical rotation plate 32 in directions different between respective half areas of the cross section of the beam thereof. As a result, for each of the information light and the reference light for recording, the direction of polarization is set to be different between the respective half areas of the cross section of the beam thereof such that the direction of polarization of the information light yet to enter the reflecting surface 5a coincides with that of the reference light for recording reflected off the reflecting surface 5a, and that the direction of polarization of the reference light for recording yet to enter the reflecting surface 5a coincides with that of the information light reflected off the reflecting surface 5a in an identical area in the information recording layer 3. As a result, in the information recording layer 3, an interference pattern resulting from interference between the information light yet to enter the reflecting surface 5a and the reference light for recording reflected off the reflecting surface 5a is recorded, and also an interference pattern resulting from interference between the reference light for recording yet to enter the reflecting surface 5a and the information light reflected off the reflecting surface 5a is recorded.

At information reproduction, the reference light for reproduction is applied to the information recording layer 3 so as to converge to become minimum in diameter at the same position where the information light and the reference light for recording converge to become minimum in diameter. Furthermore, at information reproduction, the irradiation with the reference light for reproduction and the collection of reproduction light are performed on one side of the information recording layer 3, and the reference light for reproduction and the reproduction light are arranged coaxially.

Furthermore, at information reproduction, the reference light for reproduction polarized in the first direction (P-polarized) is optically rotated by the bipartite optical rotation plate 32 in directions different between respective half areas of the cross section of the beam thereof. The light is thereby converted into reference light for reproduction in which the respective half areas of the cross section of the beam thereof have different directions of polarization, and is applied to the information recording layer 3. Then, reproduction light and return light resulting from the reference light for reproduction reflected off the reflecting surface 5a are optically rotated by the bipartite optical rotation plate 32 in directions different between the respective half areas of the cross section of the beam thereof, and thereby converted into reproduction light that is polarized in the first direction (P-polarized) across the entire cross section of the beam thereof and return light that is polarized in the second direction (S-polarized) across the entire cross section of the beam thereof, respectively. It is thereby possible to separate the reproduction light and the return light from each other by the polarization beam splitter 25 serving as a polarization separator, and consequently, it is possible to improve the SN ratio of the reproduced information.

According to the embodiment, the information light is capable of carrying information by making, use of the entire cross section of the beam thereof. The reproduction light is also capable of carrying information by making use of the entire cross section of the beam thereof.

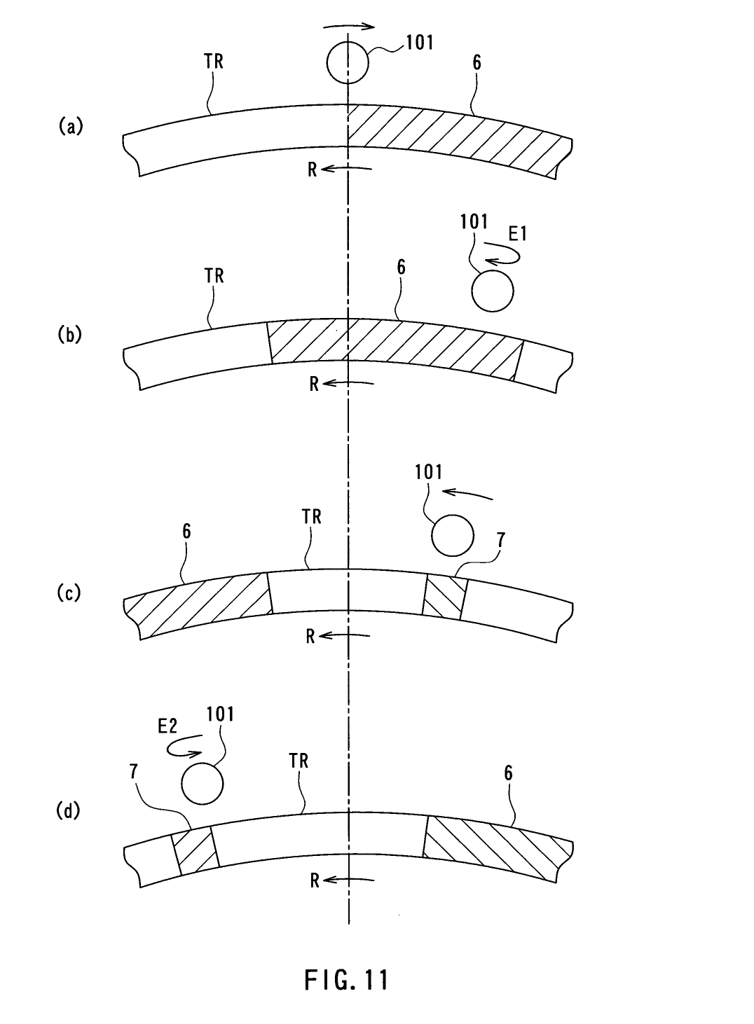

Reference is now made to FIG. 11 to describe the operation of the optical head 11 at information recording. FIG. 11 shows how a track TR and an irradiating position 101 for irradiation with the information light and the reference light for recording move during information recording. In FIG. 11, the symbol R represents the moving direction of the recording medium 1. For the sake of convenience FIG. 11 shows the irradiating position 101 so as not to fall on the track TR. In actuality, however, the irradiating position 101 falls on the track TR.

In the present embodiment, as shown in FIG. 11(a), the irradiating position 101 is moved off the neutral position in the direction (hereinafter referred to as leading direction) that is opposite to the moving direction R of the recording medium 1 before information is recorded in an information recording area 7 of the recording medium 1. Then, the irradiating position 101 passes through an address servo area 6, and the information recorded in the address servo area 6 is detected by the optical head 11.

Next, as shown in FIG. 11(b), when the irradiating position 101 has reached the end E1 of its moving range in the leading direction, the irradiating position 101 is then moved in the moving direction R of the recording medium 1 (hereinafter referred to as lagging direction). Immediately after the start of movement of the irradiating position 101 in the lagging direction, the moving speed of the irradiating position 101 is lower than the moving speed of a desired information recording area 7 in which information is to be recorded. Hence, the irradiating position 101 finally overlaps the desired information recording area 7.

As shown in FIG. 11(c), when the irradiating position 101 overlaps the desired information recording area 7, the moving speed of the irradiating position 101 is adjusted to become equal to the moving speed of the information recording area 7. Consequently, the irradiating position 101 is moved so as to follow the desired information recording area 7.

As shown in FIG. 11(d), when the irradiating position 101 has reached the end E2 of its moving range in the lagging direction, the irradiating position 101 is then moved in the leading direction again to perform the operation shown in FIG. 11(a). In this way, the operations shown in FIG. 11(a)-(d) are repeated.

As described above, in the present embodiment, the irradiating position 101 for the information light and the reference light for recording is moved so as to follow a single moving information recording area 7 for a predetermined period. Consequently, the single information recording area 7 is kept being irradiated with the information light and the reference light for recording for the predetermined period. Information is thereby recorded in the information recording area 7 in the form of an interference pattern resulting from interference between the information light and the reference light for recording. Therefore, according to the embodiment, it is possible to irradiate the information recording areas 7 with the information light and the reference light for recording for a period long enough to record information in the information recording areas 7 without causing a deviation between any of the information recording areas 7 and the irradiating position for the information light and the reference light for recording. Consequently, according to the embodiment it is possible to record information in each of a plurality of information recording areas 7 through the use of holography with a semiconductor laser which is a practical light source, for example, while rotationally moving the recording medium 1 having the information recording areas 7.

Hereinafter, description will be given in detail of the configuration and operation for correcting a displacement between the solid state image pick-up device 39 and the image of the reproduction light incident on the solid state image pick-up device 39. In the present embodiment, the information light is generated by the spatial light modulator 20 which has a plurality of pixels. The information light and the reproduction light thus have a plurality of pixels. In the present embodiment, the solid state image pick-up device 39 for detecting the reproduction light also has a plurality of pixels. For accurate reproduction of information, it is therefore necessary to align the pixels of the solid state image pick-up device 39 and the pixels of the reproduction light projected onto the solid state image pick-up device 39 with precision. Nevertheless, due to various factors, the position of the image of the reproduction light with respect to the solid state image pick-up device 39 may deviate from a desired position, and as a result, a displacement may occur between the pixels of the solid state image pick-up device 39 and the pixels of the reproduction light. The biggest factor is variations in the positional relationship between the optical system in the optical head 11 and the recording medium 1 which result from a tilt of the recording medium 1.

In the present embodiment, information on the tilt of the recording medium 1 with respect to a predetermined reference position is detected by the tilt detector 95. The information serves as reproduction light displacement information which pertains to the displacement between the solid state image pick-up device 39 and the reproduction light incident on the solid state image pick-up device 39. Based on this tilt information, the image deviation correction circuit 96 and the lens moving mechanism correct the displacement between the solid state image pick-up device 39 and the image of the reproduction light incident on the solid state image pick-up device 39. The image deviation correction circuit 96 and the lens moving mechanism correspond to the correcting unit of the invention.

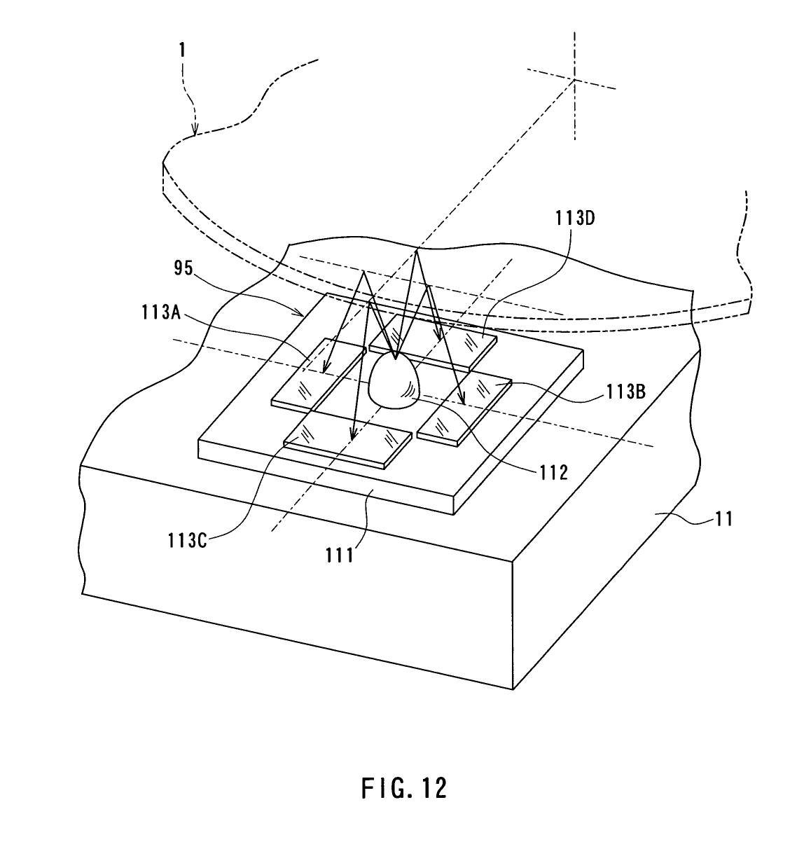

Initially, with reference to FIG. 12, description will be given of the configuration of the tilt detector 95. The tilt detector 95 has a substrate 111, a light emitting diode 112, and photodiodes 113A, 113B, 113C, and 113D. The substrate 111 is fixed to the surface of the optical head 11 facing toward the bottom surface of the recording medium 1, i.e., to the top surf ace of the optical head 11. The light emitting diode 112 and the photodiodes 113A to 113D are placed on the substrate 111. The light emitting diode 112 emits light toward the bottom surface of the recording medium 1. The photo diodes 113A to 113D are arranged around the light emitting diode 112. The photodiodes 113A and 113B are placed along the direction tangential to the tracks of the recording medium 1 so as to oppose to each other with the light emitting diode 112 in between. The photodiodes 113C and 113D are placed along the direction of the radius of the recording medium 1 so as to oppose to each other with the light emitting diode 112 in between.

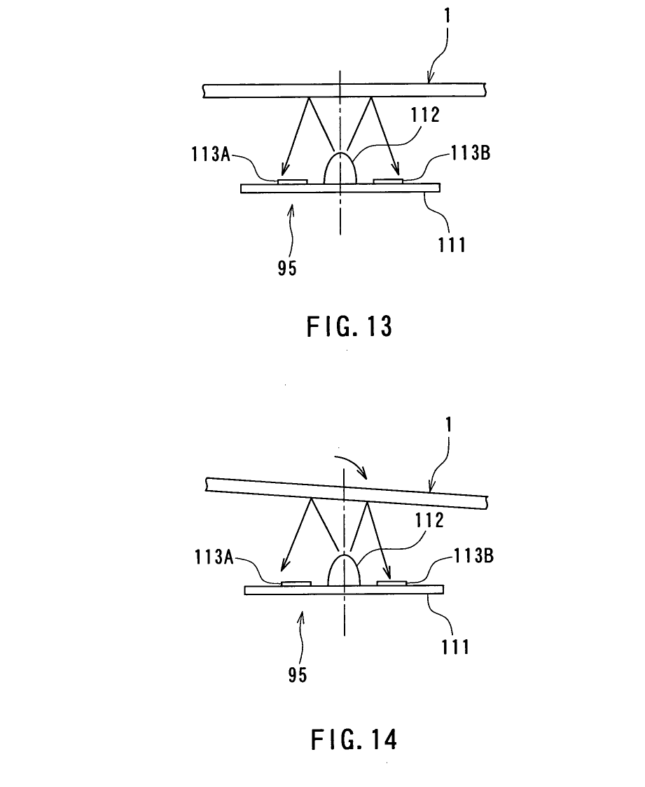

Reference is now made to FIG. 13 and FIG. 14 to describe the operation of the tilt detector 95. Initially, assume that the position of the recording medium 1 where the bottom surface thereof is in parallel to the top surface of the substrate 111 is the reference position. When the recording medium 1 is in the reference position, the light emitted from the light emitting diode 112 is reflected off the bottom surface of the recording medium 1 to enter the photodiodes 113A to 113D. In this case, the quantities of light to be received by the photodiodes 113A to 113D are set to be equal. Here, the output signals of the photodiodes 113A, 113B, 113C, and 113D shall have magnitudes PD1a, PD1b, PD1c, and PD1d, respectively. The higher the quantities of light received by the photodiodes 113A to 113D are, the greater the magnitudes PD1a to PD1d of the output signals of the photodiodes 113A to 113D become. The photodiodes 113A to 113D all have the same relationship between the quantity of light received and the magnitude of the output signal. Thus, when the recording medium 1 is in the reference position, the magnitudes PD1a to PD1d of the respective output signals of the photodiodes 113A to 113D are all equal.

FIG. 13 shows how the light emitted from the light emitting diode 112 enters the photodiodes 113A and 113B when the recording medium 1 is in the reference position. In this state, the magnitudes PD1a and PD1b of the output signals of the photodiodes 113A and 113B are equal, and therefore PD1a−PD1b=0. Although not shown, when the recording medium 1 is in the reference position, the magnitudes PD1c and PD1d of the output signals of the photodiodes 113C and 113D are equal, and therefore PD1c−PD1d=0.

FIG. 14 shows how the light emitted from the light emitting diode 112 enters the photodiodes 113A and 113B when the recording medium 1 tilts so that the distance between the recording medium 1 and the photodiode 113A is greater than the distance between the recording medium 1 and the photodiode 113B. In this state, the quantity of light received by the photodiode 113A is smaller than the quantity of light received by the photodiode 113B. Hence, PD1a−PD1b<0. The greater the tilt of the recording medium 1 from the reference position, the greater the absolute value of PD1a−PD1b.

Although not shown, in the state where the recording medium 1 tilts so that the distance between the recording medium 1 and the photodiode 113B is greater than the distance between the recording medium 1 and the photodiode 113A, the quantity of light received by the photodiode 113B is smaller than the quantity of light received by the photodiode 113A. Hence, PD1a−PD1b>0. The greater the tilt of the recording medium 1 from the reference position, the greater the absolute value of PD1a−PD1b.

Under the foregoing circumstances, the value of PD1a−PD1b can be utilized to detect the direction and magnitude of such a tilt of the recording medium 1 that the recording medium 1 rotates about a direction of the radius thereof (hereinafter referred to as tangential tilt).

Although not shown, in the state where the recording medium 1 tilts so that the distance between the recording medium 1 and the photodiode 113C is greater than the distance between the recording medium 1 and the photodiode 113D, the quantity of light received by the photodiode 113C is smaller than the quantity of light received by the photodiode 113D. Hence, PD1c−PD1d<0. The greater the tilt of the recording medium 1 from the reference position, the greater the absolute value of PD1c−PD1d.

In the state where the recording medium 1 tilts so that the distance between the recording medium 1 and the photodiode 113D is greater than the distance between the recording medium 1 and the photodiode 113C, the quantity of light received by the photodiode 113D is smaller than the quantity of light received by the photodiode 113C. Hence, PD1c−PD1d>0. The greater the tilt of the recording medium 1 from the reference position, the greater the absolute value of PD1c−PD1d.

Under the foregoing circumstances, the value of PD1c−PD1d can be utilized to detect the direction and magnitude of such a tilt of the recording medium 1 that a direction of the radius of the recording medium 1 is at an angle with respect to the top surface of the substrate 111 (hereinafter referred to as radial tilt).

The image deviation correction circuit 96 receives input of the output signals of the photodiodes 113A to 113D, and determines (PD1a−PD1b) and (PD1c−PD1d). The relationship between (PD1a−PD1b), (PD1c−PD1d) and the direction and magnitude of the displacement between the solid state image pick-up device 39 and the image of the reproduction light incident on the solid state image pick-up device 39 are determined in advance. The direction and magnitude of the foregoing displacement can thus be seen from (PD1a−PD1b) and (PD1c−PD1d). Based on the (PD1a−PD1b) and (PD1c−PD1d), the image deviation correction circuit 96 controls the lens moving mechanism so that the foregoing displacement disappears.

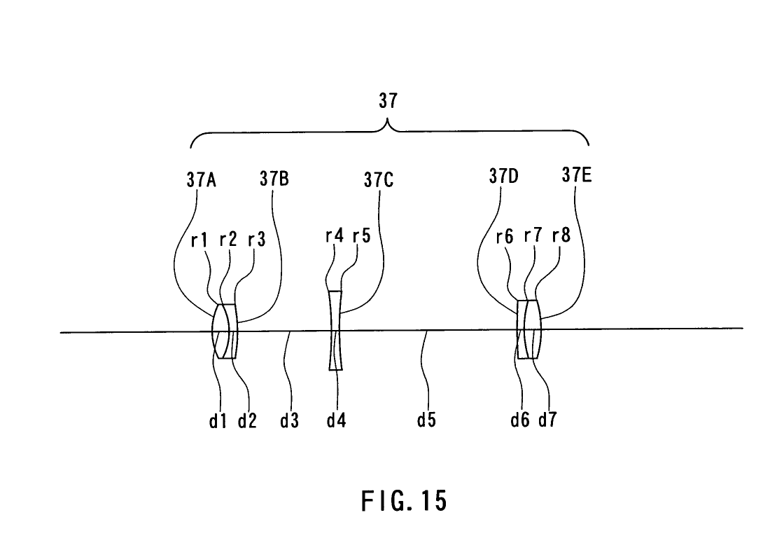

Next, with reference to FIG. 15, description will be given of the configuration of the relay lens system 37 which is capable of adjusting the position and size of the image of the reproduction light projected onto the solid state image pick-up device 39. As shown in FIG. 15, the relay lens system 37 has the convex lens 37A, the concave lens 37B, the concave lens 37C, the concave lens 37D, and the convex lens 37E that are arranged in order from the side of incidence of the reproduction light (the left in FIG. 15). As mentioned previously, the convex lens 37A and the concave lens 37B are joined with each other. The concave lens 37D and the convex lens 37E are joined with each other. The concave lens 37C is movable by means of the lens moving mechanism. The symbols r1 to r8 in FIG. 15 represent lens surfaces which are arranged in order from the side of incidence of the reproduction light. The symbols d1 to d7 in FIG. 15 represent distances between the lens surfaces.

Here, the following table shows the specification data of the relay lens system when the concave lens 37C is in a neutral position. The surface numbers in the table indicate the numbers of the lens surfaces counted up from the side of incidence of the reproduction light. R indicates the radius of curvature of each lens surface. D indicates the distance between the lens surface of corresponding No. n (n is an integer of 1 to 7) and the lens surface No. n+1 in the table. N(532) indicates the refractive index of the portion between the lens surface No. n and the lens surface No. n+1, at a wavelength of 532 nm. The symbol νd indicates the Abbe number of the portion between the lens surface No. n and the lens surface No. n+1, for d-line (587.56 nm in wavelength). ND indicates the refractive index of the portion between the lens surface No. n and the lens surface No. n+1, for d-line. Aside from the specification data shown in the following table, the condition on this relay lens system also includes: a lateral magnification of −1.75×; an object height of 3 mm in diameter; an object distance of 23.9 mm; and an image point distance of 43.7 mm.

TABLE 1

| Surface | | | | | |
|---|---|---|---|---|---|
| number | R | D | N (532) | νd | ND |
| 1 | 15.040 | 3.760 | 1.52121 | 60.3 | 1.51835 |
| 2 | −12.480 | 2.000 | 1.70663 | 30.1 | 1.69895 |
| 3 | −33.101 | 20.903 | | | |
| 4 | −72.961 | 2.000 | 1.51900 | 64.1 | 1.51633 |
| 5 | 72.961 | 41.104 | | | |
| 6 | 141.603 | 1.400 | 1.69627 | 31.1 | 1.68893 |
| 7 | 19.690 | 3.800 | 1.62137 | 55.0 | 1.61765 |
| 8 | −28.580 | | | | |

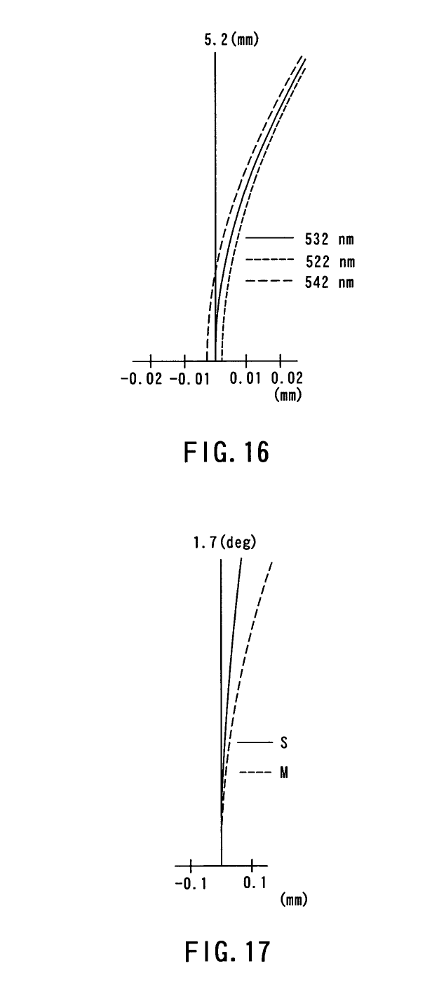

FIG. 16 is an aberration chart showing the spherical aberration and chromatic aberration of the relay lens system 37. In FIG. 16, the abscissa represents the position in the direction of the optical axis (in units of mm), and the ordinate represents the height of light beams emerging from the exit pupil (in units of mm). The maximum value on the ordinate is 5.2 mm which is the axial pupil diameter. Each curve in the diagram (aberration curve) shows the relationship between the height of a light beam emerging from the exit pupil and the position for the light beam to intersect the optical axis. FIG. 16 shows aberration curves at wavelengths of 532 nm, 522 nm, and 542 nm, respectively.

FIG. 17 is an aberration chart showing the astigmatic aberration of the relay lens system 37. In FIG. 17, the abscissa represents the position in the direction of the optical axis (in units of mm), and the ordinate represents the angle of emergence (in units of deg (degrees)). The maximum value on the ordinate is 1.7 (deg). In FIG. 17, the curve designated by the symbol S represents a sagittal image surface. The curve designated by the symbol M represents a meridional image surface.

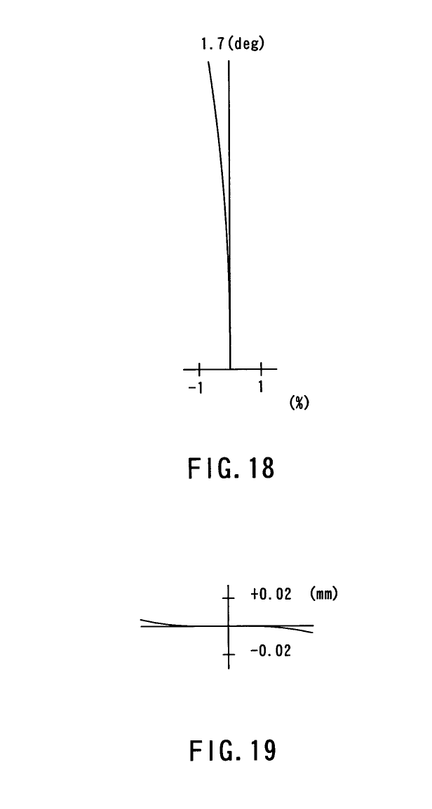

FIG. 18 is an aberration chart showing the distortion aberration of the relay lens system 37. In FIG. 18, the abscissa represents the amount of distortion of an image (in units of %). The ordinate represents the angle of emergence (in units of deg). The maximum value on the ordinate is 1.7 (deg).

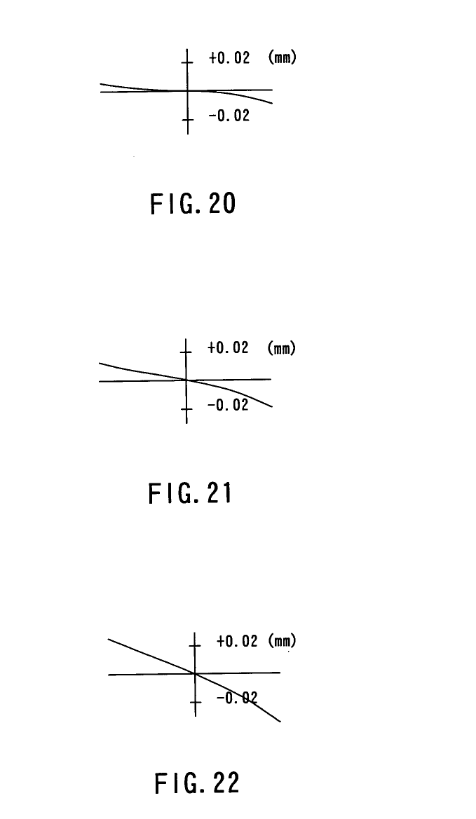

FIG. 19 to FIG. 22 are aberration charts each showing a coma aberration of the relay lens system 37. In FIG. 19 to FIG. 22, the abscissas represent a relative pupil diameter (dimensionless unit), and the ordinates represent the amount of coma aberration (in units of mm). The relative pupil diameter is a pupil diameter that is normalized such that the maximum pupil diameter in each of the angles of view in FIG. 19 to FIG. 22 is 1. FIG. 19 to FIG. 22 show aberrations at the angles of emergence of 0.00 (deg), 0.57 (deg), 1.14 (deg), and 1.71 (deg), respectively.

FIG. 17 to FIG. 22 each show the aberration curve at a wavelength of 532 nm.

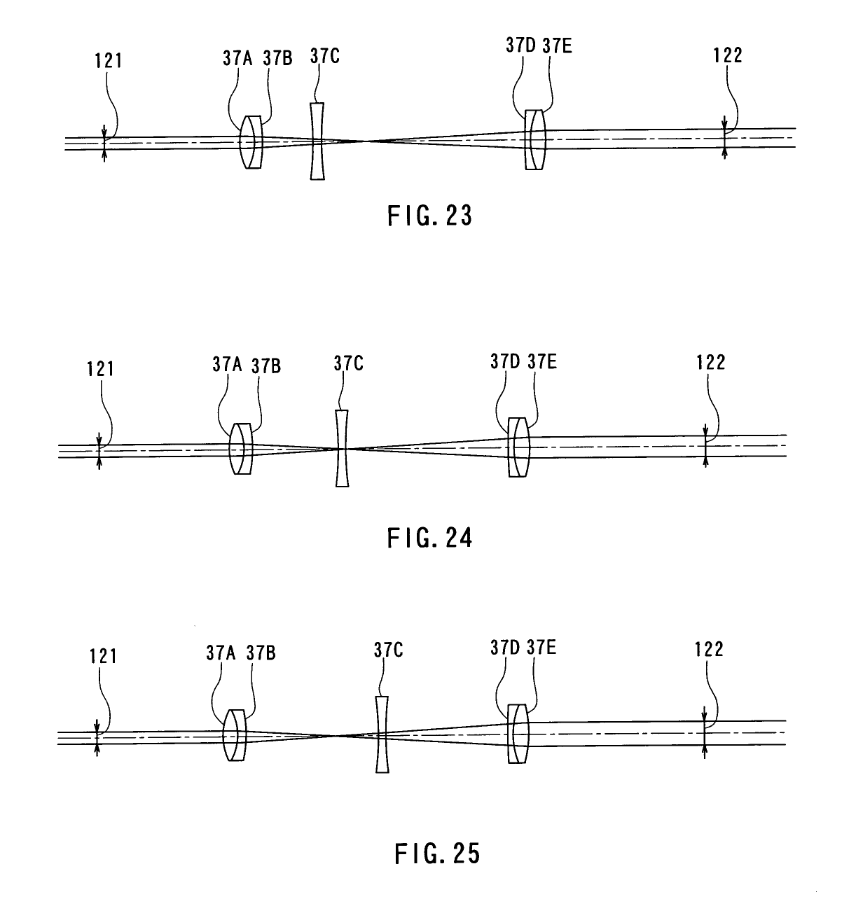

The relay lens system 37 shown in FIG. 15 is configured variable in magnification. By way of example, FIG. 23 to FIG. 25 show the states of the relay lens system 37 at magnifications of −1.53, −1.75, and −2.03, respectively. In FIG. 23 to FIG. 25, the numeral 121 represents the object surface, and the numeral 122 represents the image surface. The minus sign in the magnifications indicates that the image is an inverted image. The optical information recording/reproducing apparatus according to the present embodiment is designed so that the image of the reproduction light projected onto the solid state image pick-up device 39 has an optimum size at a magnification of −1.75. The lens 37C falls on the neutral position when the optical axes of the lenses 37A to 37E coincide with one another and the magnification is −1.75.

In the examples shown in FIG. 23 to FIG. 25, the magnification is changed by moving the lenses 37A to 37C in the direction of the optical axis. The magnification can also be changed, however, by moving the lens 37C alone in the direction of the optical axis.

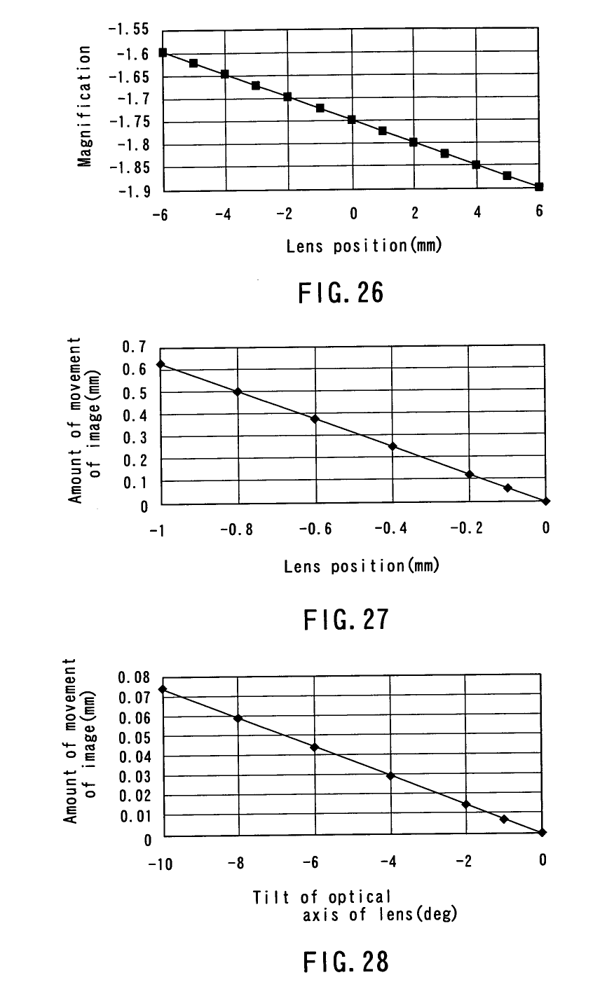

FIG. 26 is a characteristic chart showing the relationship between the position of the lens 37C and the magnification when the lens 37C alone is moved in the direction of the optical axis. In FIG. 26, the abscissa represents the position of the lens 37C in the direction of the optical axis. The ordinate represents the magnification. The position of the lens 37C is indicated with the neutral position as 0 mm. With respect to this neutral position, positions closer to the lens 37D are shown in positive values, and positions closer to the lens 37B than the neutral position are shown in negative values. The magnification of this relay lens system 37 varies by −0.025 per a 1-mm movement of the lens 37C in the direction of the optical axis.

In the relay lens system 37 shown in FIG. 15, the image of the reproduction light projected onto the solid state image pick-up device 39 can be moved in position by moving the lens 37C in a direction orthogonal to the optical axis. FIG. 27 is a characteristic chart showing the relationship between the amount of movement of the image of the reproduction light and the position of the lens 37C in the direction orthogonal to the optical axis. In FIG. 27, the abscissa represents the position of the lens 37C in the direction orthogonal to the optical axis. The ordinate represents the amount of movement of the image of the reproduction light. The position of the lens 37C is indicated with the neutral position as 0 mm. The amount of movement of the image of the reproduction light is indicated with reference to the position of the image of the reproduction light when the lens 37C is in the neutral position. In FIG. 27, the position of the lens 37C is shown in negative values and the amount of movement of the image of the reproduction light is in positive values. The reason for this is that the direction of movement of the lens 37C and the direction of movement of the image of the reproduction light are in an inverse relationship. In this relay lens system 37, the position of the image of the reproduction light moves by −0.629 mm per a 1-mm movement of the lens 37C in the direction orthogonal to the optical axis. Within the range shown in FIG. 26, changing the position of the lens 37C in the direction of the optical axis caused little variations in the relationship between the position of the lens 37C in the direction orthogonal to the optical axis and the amount of movement of the image of the reproduction light.

In the relay lens system 37 shown in FIG. 15, the image of the reproduction light projected onto the solid state image pick-up device 39 can also be moved in position by moving the lens 37C in such a direction as to change the angle formed between the traveling direction of the reproduction light incident on the lens 37C and the direction of the optical axis of the lens 37C. FIG. 28 is a characteristic chart showing the relationship between a tilt of the optical axis of the lens 37C and the amount of movement of the image of the reproduction light. In FIG. 28, the abscissa represents the tilt of the optical axis of the lens 37C. The ordinate represents the amount of movement of the image of the reproduction light. The tilt of the optical axis of the lens 37C is indicated in terms of the angle formed between the optical axis of the lens 37C and the traveling direction of the reproduction light incident on the lens 37C, i.e., the optical axis of the other lenses 37A, 37B, 37D, and 37E. The amount of movement of the image of the reproduction light is indicated with reference to the position of the image of the reproduction light when the tilt of the optical axis of the lens 37C is 0°. In the relay lens system 37, the position of the image of the reproduction light moves by −0.007 mm per a 1-deg tilt of the optical axis of the lens 37C. Within the range shown in FIG. 26, changing the position of the lens 37C in the direction of the optical axis caused little variations in the relationship between the tilt of the optical axis of the lens 37C and the amount of movement of the image of the reproduction light.

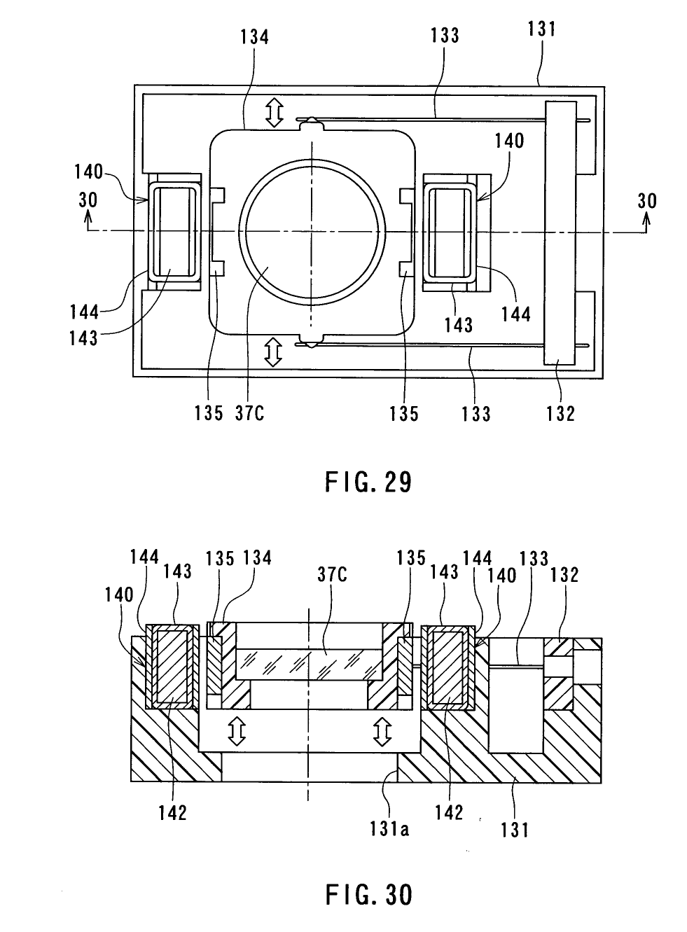

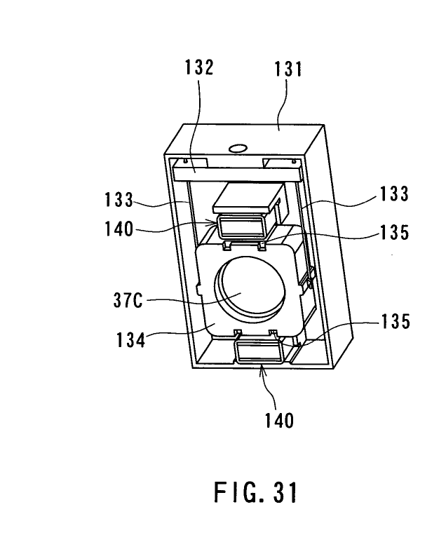

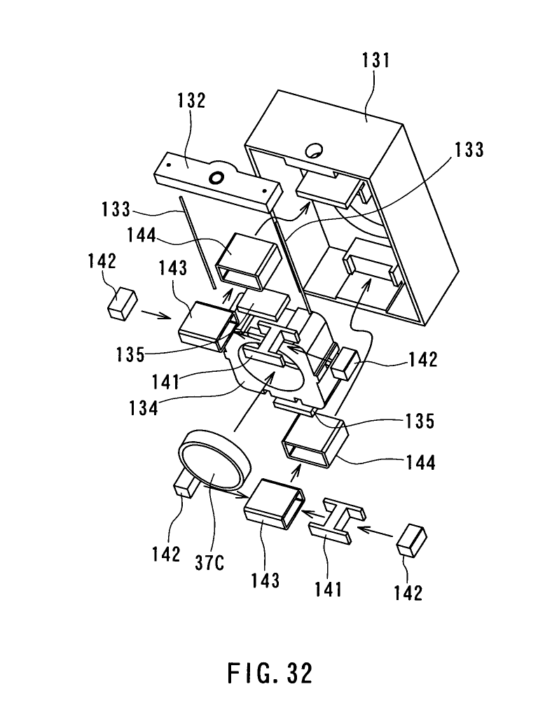

Next, the lens moving mechanism will be described with reference to FIG. 29 to FIG. 32. FIG. 29 is a front view of the lens moving mechanism. FIG. 30 is a cross-sectional view taken along line 30-30 of FIG. 29. FIG. 31 is a perspective view of the lens moving mechanism. FIG. 32 is an exploded perspective view of the lens moving mechanism.

The lens moving mechanism comprises a base 131, a wire holder 132 attached to the base 131, two suspension wires 133, a lens holder 134, and two magnets 135. The suspension wires 133 are disposed in parallel with each other, and one end of each of the suspension wires 133 is fixed to the wire holder 132. The lens holder 134 is attached to the other end of each of the suspension wires 133. The magnets 135 are attached to the lens holder 134. The lens 37C is fixed to the lens holder 134. The lens holder 134 has four side faces. The other ends of the two suspension wires 133 are fixed to two opposed side faces of the lens holder 134, respectively. The two magnets 135 are fixed to the remaining two side faces of the lens holder 134. The base 131 has an opening 131a for allowing light to enter the lens 37C.

The lens moving mechanism further comprises two coil assemblies 140 that are disposed to face the two magnets 135 and fixed to the base 131. As shown in FIG. 32, each of the coil assemblies 140 has a yoke holder 141, yokes 142 attached to the yoke holder 141, a coil 143 for parallel movement that surrounds the yoke holder 141 and the yokes 142, and a coil 144 for zoom that surrounds the coil 143.

Next, description will be given of the operation of the lens moving mechanism shown in FIG. 29 to FIG. 32. According to this lens moving mechanism, the lens 37C can be moved in the direction orthogonal to the optical axis thereof (the vertical direction in FIG. 29) by energizing the coil 143.

According to this lens moving mechanism, by controlling the directions and intensities of the currents to be passed through the two coils 144 for zoom, the lens 37C can be moved in the direction of the optical axis thereof (the vertical direction in FIG. 30), and in such a direction as to change the angle formed between the traveling direction of the reproduction light incident on the lens 37C and the direction of the optical axis of the lens 37C.

According to this lens moving mechanism, the size of the image of the reproduction light projected onto the solid state image pick-up device 39 can be adjusted by moving the lens 37C in the direction of the optical axis. In addition, the image of the reproduction light projected onto the solid state image pick-up device 39 can be moved in a predetermined first direction by moving the lens 37C in the direction orthogonal to the optical axis. Furthermore, a movement in a second direction orthogonal to the foregoing first direction is achieved by moving the lens 37C in such a direction as to change the angle formed between the traveling direction of the reproduction light incident on the lens 37C and the direction of the optical axis of the lens 37C.

Displacements to occur between the pixels of the solid state image pick-up device 39 and the pixels of the reproduction light due to the tilt of the recording medium 1 include one resulting from radial tilt and one resulting from tangential tilt. The directions of the two displacements are orthogonal to each other. The displacement resulting from radial tilt is often greater than the displacement resulting from tangential tilt. Meanwhile, as seen from FIG. 27 and FIG. 28, a large amount of image movement can be achieved more easily by moving the lens 37C in the direction orthogonal to the optical axis than by tilting the optical axis of the lens 37C. It is thus preferable to adopt such a setting that the displacement resulting from radial tilt is corrected by moving the lens 37C in the direction orthogonal to the optical axis and the displacement resulting from tangential tilt is corrected by tilting the optical axis of the lens 37C. The relationships of the direction and magnitude of movement of the lens 37C with the movement and size of the image of the reproduction light on the solid state image pick-up device 39 are determined in advance.

As described above, in the present embodiment, information on the tilt of the recording medium 1 is detected by the tilt detector 95. The information serves as reproduction light displacement information which pertains to the displacement between the solid state image pick-up device 39 and the reproduction light incident on the solid state image pick-up device 39. Based on this tilt information, the image deviation correction circuit 96 and the lens moving mechanism correct the displacement to eliminate it. According to the present embodiment, it is thus possible to accurately reproduce two-dimensional image information from the recording medium 1.

[Second Embodiment]

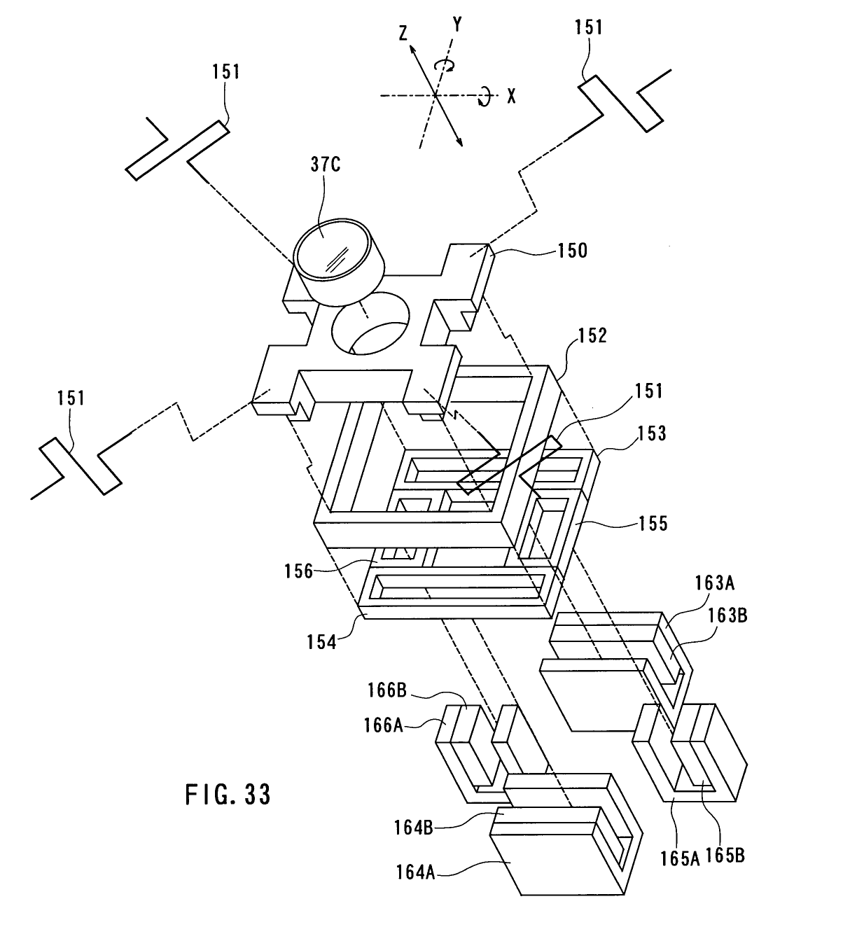

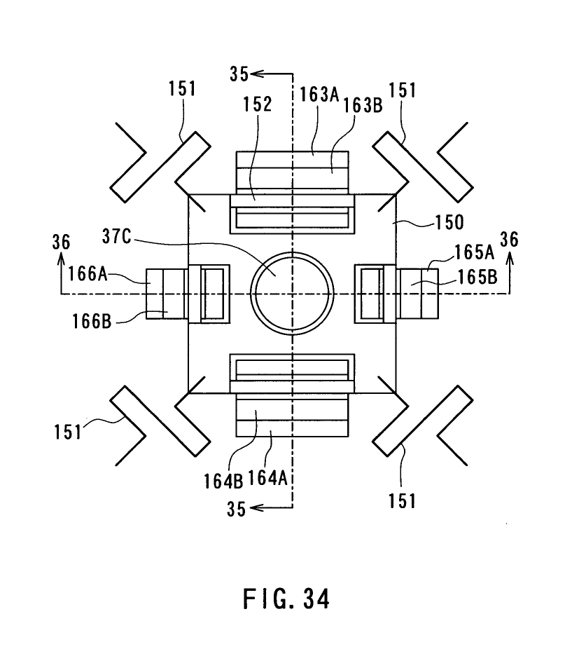

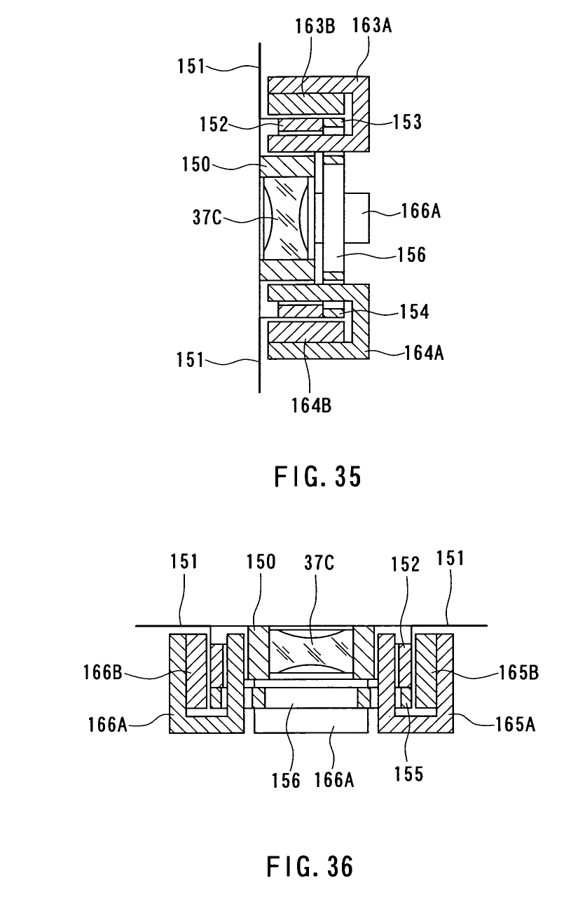

Now, with reference to FIG. 33 to FIG. 36, description will be given of an optical information recording/reproducing apparatus according to a second embodiment of the invention. The present embodiment differs from the first embodiment in the lens moving mechanism alone. FIG. 33 is an exploded perspective view of the lens moving mechanism of the present embodiment. FIG. 34 is a front view of the lens moving mechanism of the present embodiment. FIG. 35 is a cross-sectional view taken along the line 35-35 of FIG. 34. FIG. 36 is a cross-sectional view taken along the line 36-36 of FIG. 34.

The lens moving mechanism of the present embodiment comprises a lens holder 150 for holding the lens 37C, and four suspension wires 151 for suspending this lens holder 150. The lens moving mechanism further comprises a coil 152 joined to one of the surfaces of the lens holder 150, and four coils 153 to 156 joined to the surface of the coil 152 opposite from the lens holder 150. The coils 152 to 156 are all rectangular in general shape. The coils 153 and 154 are joined to two parallel sides out of the four sides of the coil 152. The coils 155 and 156 are joined to the remaining two sides out of the four sides of the coil 152.

The lens moving mechanism further comprises yokes 163A to 166A and magnets 163B to 166B. The yokes 163A to 166A are shaped to sandwich one of the sides of the coils 153 to 156, respectively. The magnets 163B to 166B are firmly fixed to the yokes 163A to 166A, respectively.

Next, description will be given of the operation of the lens moving mechanism shown in FIG. 33 to FIG. 36. In the following description, as shown in FIG. 33, the direction of the optical axis of the lens 37C shall be Z-axis, and two directions that are orthogonal to the direction of the optical axis of the lens 37C and orthogonal to each other as well shall be X-axis and Y-axis. The X-axis is in parallel with the two sides of the coil 152 that the coils 153 and 154 are joined to. The Y-axis is in parallel with the two sides of the coil 152 that the coils 155 and 156 are joined to.

According to this lens moving mechanism, the lens 37C can be moved along the Z-axis by energizing the coil 152. Moreover, the lens 37C can be moved so as to rotate about the X-axis by energizing the coils 153 and 154. Furthermore, the lens 37C can be moved so as to rotate about the Y-axis by energizing the coils 155 and 156.

According to this lens moving mechanism, the size of the image of the reproduction light projected onto the solid state image pick-up device 39 can be adjusted by moving the lens 37C in the direction of the optical axis. Furthermore, the position of the image of the reproduction light projected onto the solid state image pick-up device 39 can be moved in a predetermined first direction by moving the lens 37C so as to rotate about the X-axis. Furthermore, a movement in a second direction orthogonal to the foregoing first direction is achieved by moving the lens 37C so as to rotate about the Y-axis. The relationships of the direction and magnitude of movement of the lens 37C with the direction of movement and size of the image of the reproduction light on the solid state image pick-up device 39 are determined in advance.

The remainder of the configuration, operations, and effects of the second embodiment are similar to those of the first embodiment.

[Third Embodiment]

Now, description will be given of an optical information recording/reproducing apparatus according to a third embodiment of the invention. The optical information recording/reproducing apparatus according to the present embodiment is not provided with the tilt detector 95 of the first embodiment, but uses the quadripartite photodetector 49 to detect the tilt of the recording medium 1 with respect to a predetermined reference position. Thus, in the present embodiment, the quadripartite photodetector 49 functions as both the reference light position information detector and the reproduction light displacement detector. The image deviation correction circuit 96 of the present embodiment receives input of the output signals of the quadripartite photodetector 49, not the output signals of the tilt detector 95.

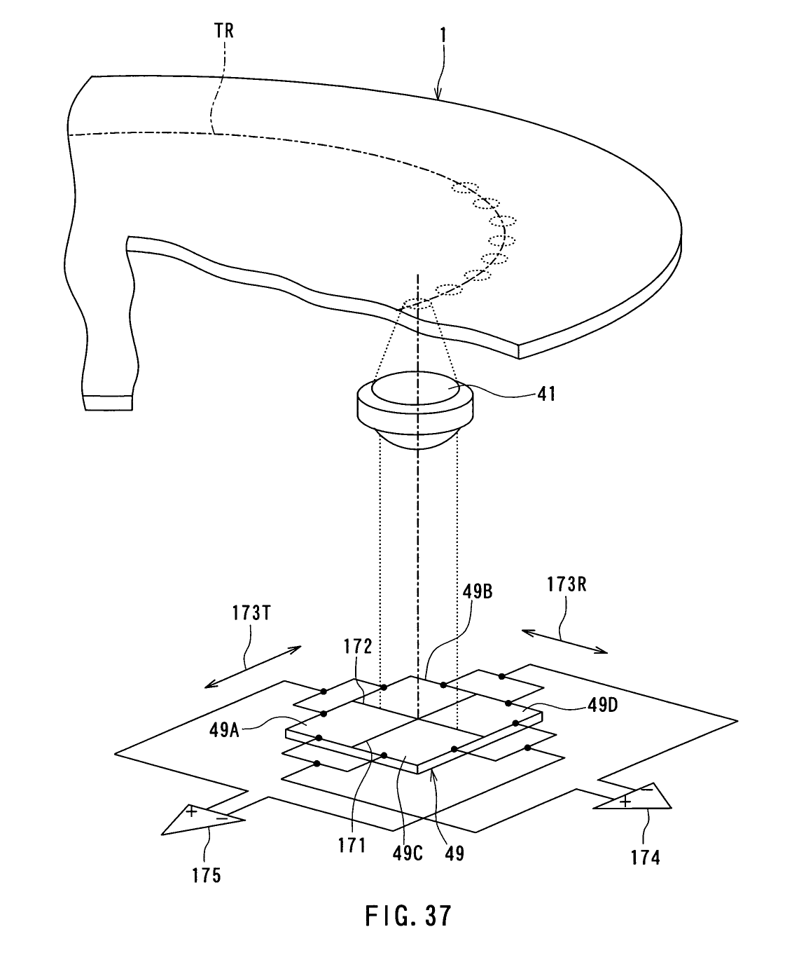

Next, the method of detecting the tilt of the recording medium 1 by using the quadripartite photodetector 49 will be described with reference to FIG. 37. As shown in FIG. 37, the quadripartite photodetector 49 has four light receiving portions 49A, 49B, 49C, and 49D which are divided by a division line 171 parallel with a direction corresponding to the track direction of the recording medium 1 and a division line 172 orthogonal thereto. In FIG. 37, the light receiving portions 49A and 49B are opposite to the light receiving portions 49C and 49D across the division line 171. The light receiving portions 49A and 49C are opposite to the light receiving portions 49B and 49D across the division line 172. The output signals of the light receiving portions 49A to 49D are inputted to the image deviation correction circuit 96.

For the periods in which the light emitted from the objective lens 41 is passing through the address servo areas 6, the quadripartite photodetector 49 is used to generate a focus error signal FE, a tracking error signal TE, and a reproduction signal RF.

In the present embodiment, during information reproduction, the quadripartite photodetector 49 is used to detect the tilt of the recording medium 1. In the present embodiment, the light source device 45 emits red light even during information reproduction, so that the return light from the recording medium 1 corresponding to the red light applied to the recording medium 1 is received by the quadripartite photodetector 49. Here, if the recording medium 1 has no tilt, the return light is incident on the central portion of the quadripartite photodetector 49 so that the output signals of the light receiving portions 49A to 49D are identical in magnitude. Hereinafter, the magnitudes of the output signals of the light receiving portions 49A to 49D will be represented by PD2a to PD2d.

When the recording medium 1 has a tangential tilt, the position of incidence of the return light on the quadripartite photodetector 49 moves in the arrowed direction designated by the symbol 173T in FIG. 37. As a result, a difference occurs between (PD2a+PD2c) and (PD2b+PD2d). The direction and magnitude of the tangential tilt can thus be detected from the value of (PD2a+PD2c)−(PD2b+PD2d).

When the recording medium 1 has a radial tilt, the position of incidence of the return light on the quadripartite photodetector 49 moves in the arrowed direction designated by the symbol 173R in FIG. 37. As a result, a difference occurs between (PD2a+PD2b) and (PD2c+PD2d). The direction and magnitude of the radial tilt can thus be detected from the value of (PD2a+PD2b)−(PD2c+PD2d).

The image deviation correction circuit 96 of the present embodiment has an operational amplifier 174 for calculating (PD2a+PD2c)−(PD2b+PD2d), and an operational amplifier 175 for calculating (PD2a+PD2b)−(PD2c+PD2d). The image deviation correction circuit 96 controls the lens moving mechanism based on the output signals of the operational amplifiers 174 and 175.

The remainder of the configuration, operations, and effects of the third embodiment are similar to those of the first embodiment.

[Fourth Embodiment]

Now, description will be given of an optical information recording/reproducing apparatus according to a fourth embodiment of the invention. The optical information recording/reproducing apparatus according to the present embodiment is not provided with the tilt detector 95 of the first embodiment, but uses the solid state image pick-up device 39 to directly detect the displacement between the solid state image pick-up device 39 and the reproduction light incident thereon. Thus, in the present embodiment, the solid state image pick-up device 39 functions as both the reproduction light detector and the reproduction light displacement detector. The image deviation correction circuit 96 of the present embodiment receives input of the output signals of the signal processing circuit 89, not the output signals of the tilt detector 95.

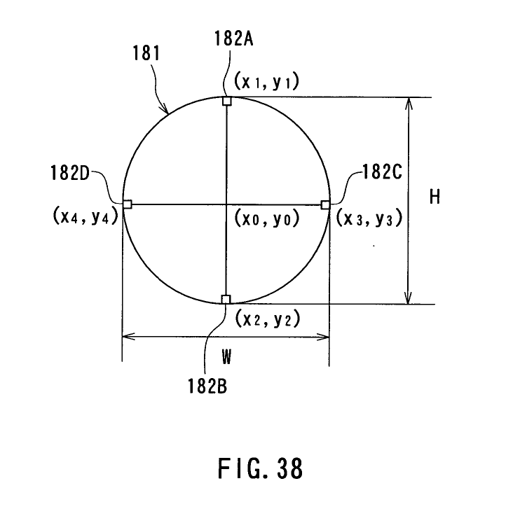

Next, with reference to FIG. 38, description will be given of the method of detecting the above-mentioned displacement through the use of the solid state image pick-up device 39. FIG. 38 shows an image 181 of the reproduction light projected onto the solid state image pick-up device 39. In the present embodiment, when the spatial light modulator 20 generates information light, four marks 182A to 182D for positional recognition are inserted to the information light. The marks 182A to 182D are located at the top, bottom, right and left ends of the light beam of the information light, respectively. The marks 182A to 182D each have a predetermined two-dimensional pattern which is formed by using some of the pixels of the spatial light modulator 20. In the present embodiment, since the information light contains the marks 182A to 182D as described above, the image 181 of the reproduction light also contains the marks 182A to 182D.

Based on the output signal of the signal processing circuit 89 which processes the output signals of the solid state image pick-up device 39, the image displacement correction circuit 96 of the present embodiment recognizes the marks 182A to 182D and detects the positions of the marks 182A to 182D on the solid state image pick-up device 39. The positions of the marks 182A to 182D are represented by the positions of predetermined pixels in the respective marks 182A to 182D, e.g., the center pixels. From the positions of the marks 182A to 182D, the image deviation correction circuit 96 detects the direction and magnitude of the displacement between the solid state image pick-up device 39 and the reproduction light incident on the solid state image pick-up device 39, and the size of the image 181 of the reproduction light on the solid state image pick-up device 39, in the following manner.

Assume here that the horizontal direction in FIG. 38 is X-axis and the vertical direction in FIG. 38 is Y-axis. The positions of the marks 182A to 182D on the solid state image pick-up device 39 are represented by the coordinates (x₁, y₁), (x₂, y₂), (x₃, y₃), and (x₄, y₁), respectively. The center position of the image 181 of the reproduction light on the solid state image pick-up device 39 is represented by the coordinates (x₀, y₀). The solid state image pick-up device 39 is located such that x₁=x₂, and y₃=y₄ in advance.

The image deviation correction circuit 96 determines the coordinates (x₀, y₀) of the center position from the following equations:

x₀=(x₁+x₂)/2, and

y₀=(y₃+y₄)/2.

The image deviation correction circuit 96 compares the coordinates (x₀, y₀) of the center position of the image 181 of the reproduction light with a predetermined desired position, and detects the direction and magnitude of the displacement between the solid state image pick-up device 39 and the reproduction light incident on the solid state image pick-up device 39. Then, the image deviation correction circuit 96 controls the lens moving mechanism so that the foregoing displacement disappears.

The image deviation correction circuit 96 determines the height H and width W of the image 181 from the following equations:

H=y₁−y₂

W=x₃−x₄

The image deviation correction circuit 96 determines the diameter R of the image 181 from the following equations:

R=(H+W)/2

The image deviation correction circuit 96 compares the diameter R of the image 181 with a predetermined desired diameter, and detects the deviation of the size of the image 181 from the desired size. Then, the image deviation correction circuit 96 controls the lens moving mechanism to adjust the magnification of the relay lens system 37 so that the foregoing deviation disappears.

The remainder of the configuration, operations, and effects of the fourth embodiment are similar to those of the first embodiment.

The invention is not limited to the foregoing embodiments but may be modified in various ways. For example, in the embodiments, the displacement between the solid state image pick-up device 39 and the reproduction light incident on the solid state image pick-up device 39 is corrected by moving the lens 37C which constitutes part of the recording/reproducing optical system. Nevertheless, according to the invention, an optical element for changing the traveling direction of light statically may be inserted into the recording/reproducing optical system so that this optical element is used to correct the foregoing displacement. According to the invention, the foregoing displacement may also be corrected by moving the solid state image pick-up device 39 instead of moving the reproduction light incident on the solid state image pick-up device 39.

In the embodiments, information is recorded on a multiplex basis by phase-encoding multiplexing. Nevertheless, the invention also covers the case where multiplex recording by phase-encoding multiplexing is not conducted. In the embodiments, at information recording, the irradiating position for the information light and the reference light for recording is controlled so as to follow a single moving information recording area 7 over a predetermined period. Nevertheless, the invention also covers the case where no such control is exercised.

As has been described, according to the optical information reproducing apparatus of the invention, the reproduction light occurring from a recording medium irradiated with reference light for reproduction is detected by the reproduction light detector. The reproduction light displacement detector detects reproduction light displacement information which pertains to the displacement between the reproduction light detector and the reproduction light incident on the reproduction light detector. Based on this information, the displacement is corrected by the correction unit. According to the invention, it is therefore possible to reproduce two-dimensional image information accurately from a recording medium through the use of holography.

According to the optical information recording/reproducing apparatus of the invention, at information recording, the recording medium is irradiated with information light and reference light for recording, so that two-dimensional image information is recorded on the recording medium by means of interference between the information light and the reference light for recording. At information reproduction, reproduction light occurring from the recording medium irradiated with reference light for reproduction is detected by the reproduction light detector. The reproduction light displacement detector detects reproduction light displacement information which pertains to the displacement between the reproduction light detector and the reproduction light incident on the reproduction light detector. Based on this information, the displacement is corrected by the correction unit. According to the invention, it is therefore possible to record two-dimensional image information on a recording medium through the use of holography and reproduce the two-dimensional image information from the recording medium through the use of holography. The invention allows accurate reproduction of two-dimensional image information from a recording medium, in particular.

It is apparent from the foregoing description that the invention may be carried out in various modes and may be modified in various ways. It is therefore to be understood that within the scope of equivalence of the following claims the invention may be practiced in modes other than the foregoing embodiments.

What is claimed is:

1. An optical information reproducing apparatus for reproducing two-dimensional image information from a recording medium through the use of holography, the two-dimensional image information being recorded on the recording medium by means of interference between information light carrying the two-dimensional image information and reference light for recording, the apparatus comprising:
a reproduction reference light generator for generating reference light for reproduction;
a reproducing optical system for irradiating the recording medium with the reference light for reproduction generated by the reproduction reference light generator, and collecting reproduction light occurring from the recording medium irradiated with the reference light for reproduction, the reproduction light carrying the two-dimensional image information;
a reproduction light detector for detecting the reproduction light collected by the reproducing optical system and incident on the reproduction light detector;
a reproduction light displacement detector for detecting reproduction light displacement information pertaining to a displacement between the reproduction light detector and the reproduction light incident on the reproduction light detector; and
a correction unit for correcting the displacement based on the reproduction light displacement information detected by the reproduction light displacement detector.

2. An optical information reproducing apparatus according to claim 1, wherein the reproduction light displacement detector detects information on a tilt of the recording medium with respect to a predetermined reference position as the reproduction light displacement information.

3. An optical information reproducing apparatus according to claim 1, further comprising a reference light position information detector for detecting information on a positional relationship between the recording medium and the reference light for reproduction incident on the recording medium,
wherein the reproduction light displacement detector uses the reference light position information detector to detect information on a tilt of the recording medium with respect to a predetermined reference position as the reproduction light displacement information.

4. An optical information reproducing apparatus according to claim 1, wherein the reproduction light displacement detector uses the reproduction light detector to detect the reproduction light displacement information.

5. An optical information reproducing apparatus according to claim 1, wherein the correction unit has a lens for correction that constitutes part of the reproducing optical system, and a moving mechanism for moving the lens for correction.

6. An optical information reproducing apparatus according to claim 5, wherein the moving mechanism moves the lens for correction in at least one direction out of a direction intersecting an optical axis of the lens for correction, a direction of the optical axis of the lens for correction, and such a direction as to change the angle formed between a traveling direction of the reproduction light incident on the lens for correction and the direction of the optical axis of the lens for correction.

7. An optical information recording/reproducing apparatus for recording two-dimensional image information on a recording medium through the use of holography and reproducing the two-dimensional image information from the recording medium through the use of holography, the apparatus comprising:
an information light generator for generating information light carrying the two-dimensional image information;
a recording reference light generator for generating reference light for recording;
a reproduction reference light generator for generating reference light for reproduction;
a recording/reproducing optical system for, to record information, irradiating the recording medium with the information light generated by the information light generator and the reference light for recording generated by the recording reference light generator so that the two-dimensional image information is recorded on the recording medium by means of interference between the information light and the reference light for recording, and, to reproduce information, irradiating the recording medium with the reference light for reproduction generated by the reproduction reference light generator and collecting reproduction light occurring from the recording medium irradiated with the reference light for reproduction, the reproduction light carrying the two-dimensional image information;
a reproduction light detector for detecting the reproduction light collected by the recording/reproducing optical system and incident on the reproduction light detector;
a reproduction light displacement detector for detecting reproduction light displacement information pertaining to a displacement between the reproduction light detector and the reproduction light incident on the reproduction light detector; and
a correction unit for correcting the displacement based on the reproduction light displacement information detected by the reproduction light displacement detector.

8. An optical information recording/reproducing apparatus according to claim 7, wherein the reproduction light displacement detector detects information on a tilt of the recording medium with respect to a predetermined reference position as the reproduction light displacement information.

9. An optical information recording/reproducing apparatus according to claim 7, further comprising a reference light position information detector for detecting information on a positional relationship between the recording medium and the reference light for reproduction incident on the recording medium,
wherein the reproduction light displacement detector uses the reference light position information detector to detect information on a tilt of the recording medium with respect to a predetermined reference position as the reproduction light displacement information.

10. An optical information recording/reproducing apparatus according to claim 7, wherein the reproduction light displacement detector uses the reproduction light detector to detect the reproduction light displacement information.

11. An optical information recording/reproducing apparatus according to claim 7, wherein the correction unit has a lens for correction that constitutes part of the recording/reproducing optical system, and a moving mechanism for moving the lens for correction.

12. An optical information recording/reproducing apparatus according to claim 11, wherein the moving mechanism moves the lens for correction in at least one direction out of a direction intersecting an optical axis of the lens for correction, a direction of the optical axis of the lens for correction, and such a direction as to change the angle formed between a traveling direction of the reproduction light incident on the lens for correction and the direction of the optical axis of the lens for correction.
